(19) United States
(12) Patent Application Publication
(10) Pub. No.: US 2006/0291506 A1
(43) Pub. Date: Dec. 28, 2006

(54) Process of providing content component displays with a digital video recorder

(76) Inventor: David Charles Cain, Richardson, TX (US)

Correspondence Address: David Cain;Suite 143, 1333 W. Campbell Rd., Richardson, TX, 75080, US

(21) Appl. No.: 11/159,805

(22) Filed: Jun. 23, 2005

(51) Int. Cl. H04J 1/00

(52) U.S. Cl. 370/486

(57) ABSTRACT

A process of providing a content display signal including display components may be performed by receiving input indicating display components and receiving input indicating content. A composite signal is generated including indicated display components and indicated content. The composite signal is provided to a display device.

### TECHNICAL FIELD OF THE INVENTION

The method and system relate to the field of media content distribution and display.

### BACKGROUND OF THE INVENTION

With the introduction of digital video recorders, media presentation has changed radically. The bandwidth that can be devoted to an entertainment or information broadcast can be determined by the level of interest rather than limits to the bandwidth.

What is needed, therefore, is a media content distribution system for providing layered media content.

### SUMMARY OF THE INVENTION

A process of providing a content display signal including display components may be performed by receiving input indicating display components and receiving input indicating content. A composite signal is generated including indicated display components and indicated content. The composite signal is provided to a display device.

### BRIEF DESCRIPTION OF THE DRAWINGS

For a more complete understanding of the present invention and the advantages thereof, reference is now made to the following description taken in conjunction with the accompanying Drawings in which:

FIG. 1 illustrates a modular media recording system;

FIG. 2 illustrates an individualized content distribution system;

FIG. 3 illustrates a signal processing media recorder;

FIG. 4 illustrates a mixed content generation process;

FIG. 5 illustrates a video distribution system;

FIG. 6 illustrates a conditional access module;

FIG. 7 illustrates a recording process;

FIG. 8 illustrates a media recorder gaming process;

FIG. 9 illustrates a layered content presentation process;

FIG. 10 illustrates a mixed content display system;

FIG. 11 illustrates a recorded video distribution system;

FIG. 12 illustrates a media recorder;

FIG. 13 illustrates an advertising content value process;

FIG. 14 illustrates a media recorder gaming system;

FIG. 15 illustrates a content distribution system;

FIG. 16 illustrates a layered media distribution system;

FIG. 17 illustrates a media recorder;

FIG. 18 illustrates an MPEG encoder;

FIG. 19 illustrates an individualized content distribution process;

FIG. 20 illustrates a composite video media recorder system;

FIG. 21 illustrates an associated component process;

FIG. 22 illustrates a cellular phone—remote control; and

FIG. 23 illustrates an MPEG decoder.

### DETAILED DESCRIPTION OF THE INVENTION

Referring now to the drawings, wherein like reference numbers are used to designate like elements throughout the various views, several embodiments are further described. The figures are not necessarily drawn to scale, and in some instances the drawings have been exaggerated or simplified for illustrative purposes only. One of ordinary skill in the art will appreciate the many possible applications and variations of the disclosed embodiments based on the following examples of possible embodiments. The disclosed systems, components and processes contemplate substitution and combination of the disclosed systems, components and processes, even where the substitutions and combinations are not expressly disclosed. For purposes of explanation, numerous specific details are set forth in order to provide a thorough understanding of the disclosed embodiments. It will be evident, however, to one skilled in the art that the disclosed embodiments may be practiced without these specific details. As one example, the terms subscriber, user, viewer are used interchangeably throughout this description. In some instances, well-known structures and devices are shown in block diagram form, rather than in detail, in order to avoid obscuring the disclosure. These embodiments are described in sufficient detail to enable those skilled in the art to practice the invention, and it is to be understood that other embodiments may be utilized and that logical, mechanical, electrical, and other changes may be made without departing from the scope of the present invention. Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of acts leading to a desired result. The acts are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, signals, datum, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. The disclosed embodiments may be implemented by an apparatus for performing the operations herein. This apparatus may be specially constructed for the required purposes, or it may comprise a general-purpose computer, selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus. The algorithms and processes presented herein are not inherently related to any particular computer or other apparatus. Various general-purpose systems may be used with programs in accordance with the teachings herein, or it may prove convenient to construct more specialized apparatus to perform the required method. For example, any of the methods according to disclosed embodiments can be implemented in hard-wired circuitry, by programming a general-purpose processor or by any combination of hardware and software. One of skill in the art will immediately appreciate that the disclosed embodiments may be practiced with computer system configurations other than those described below, including hand-held devices, multiprocessor systems, microprocessor-based or programmable consumer electronics, DSP devices, network PCs, minicomputers, mainframe computers, and the like. The disclosed embodiments may also be practiced in distributed computing environments where tasks are performed by remote processing devices that are linked through a communications network. The required structure for a variety of these systems will appear from the description below. The methods of the disclosed embodiments may be implemented using computer software. If written in a programming language conforming to a recognized standard, sequences of instructions designed to implement the methods can be compiled for execution on a variety of hardware platforms and for interface to a variety of operating systems. In addition, the disclosed embodiments are not described with reference to any particular programming language. It will be appreciated that a variety of programming languages may be used to implement the teachings of the disclosure as described herein. Furthermore, it is common in the art to speak of software, in one form or another (e.g., program, procedure, application, etc.), as taking an action or causing a result. Such expressions are merely a shorthand way of saying that execution of the software by a computer causes the processor of the computer to perform an action or produce a result.

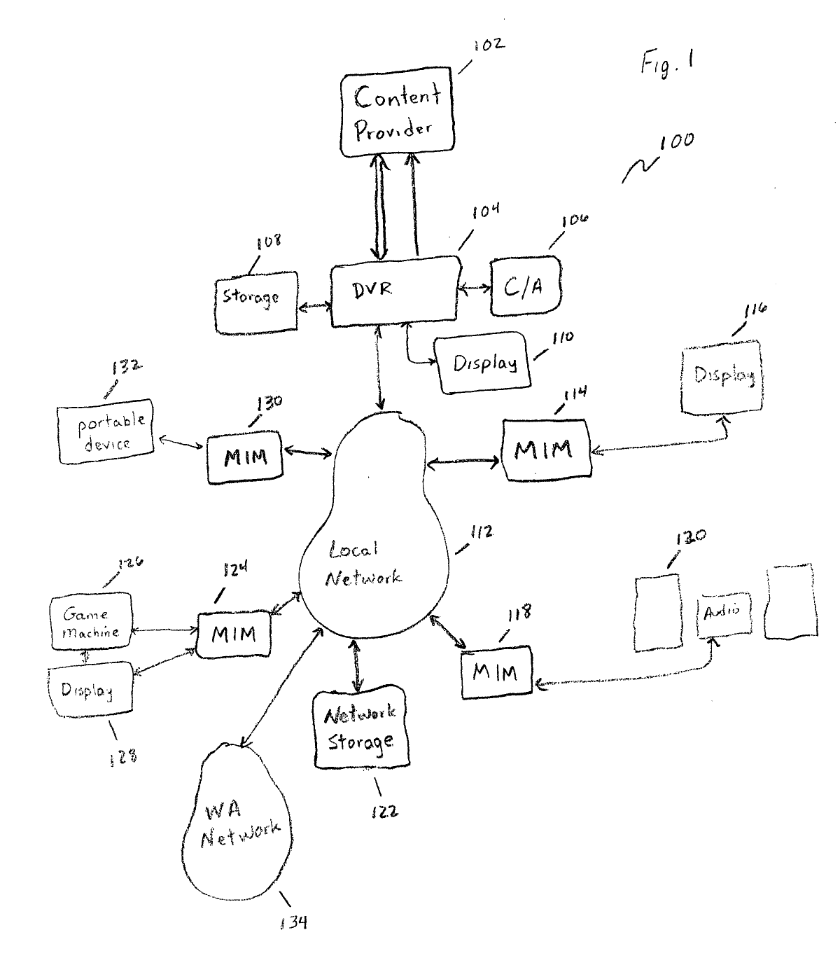

With reference to FIG. 1, a modular media recording system 100 is shown. A media recorder 104 receives content from a content provider 102. Selected content is recorded by the media recorder 104 on storage device 108 or network storage device 122. A conditional access module 106 typically confirms the authorization and enables the reception of content signals from content provider 102. The media recorder 104 may provide recorded content signals to display 110 for viewing. Media recorder 104 may be connected to a local network 112. Local area network 112 may provide connection to network storage devices 122 and wide-area network 134. Local network 112 may provide connection to one or more media interface modules 114, 118, 124 and 130. The media interface modules 114, 118, 124 and 130 provide local interface and command for the media recorder 104 functions, but typically do not include receivers or data storage. The media interface modules 114, 118, 124 and 130 may be connected to displays 116, audio equipment 120, game machine 126 and display 128, portable device 132 or other suitable systems or devices.

These favorites lists are usually created by a user selecting a channel via a selection device, and then entering a command via a user interface to add the channel to the favorites list. To delete a channel from the favorites list, the user typically enters the user interface for editing the favorites list, and manually enters a command into the selection device to delete the channel from the favorites list. Electronic guides may include personalization. Typically, a household utilizing a content device, such as a television device, involves more than one user. For example, one or more children along with two adult parents may view a single household television device located in a living area either together or individually. The favorites list provided by current electronic guides may include one favorites list is usually available per television device. The favorites list may be made specific to each user. A content guide may support a user-friendly content selection GUI with the capability of handling information regarding an enormous amount of available content. A content guide may incorporate multiple types and sources of content, content description information about which is presented on the content selection GUI.

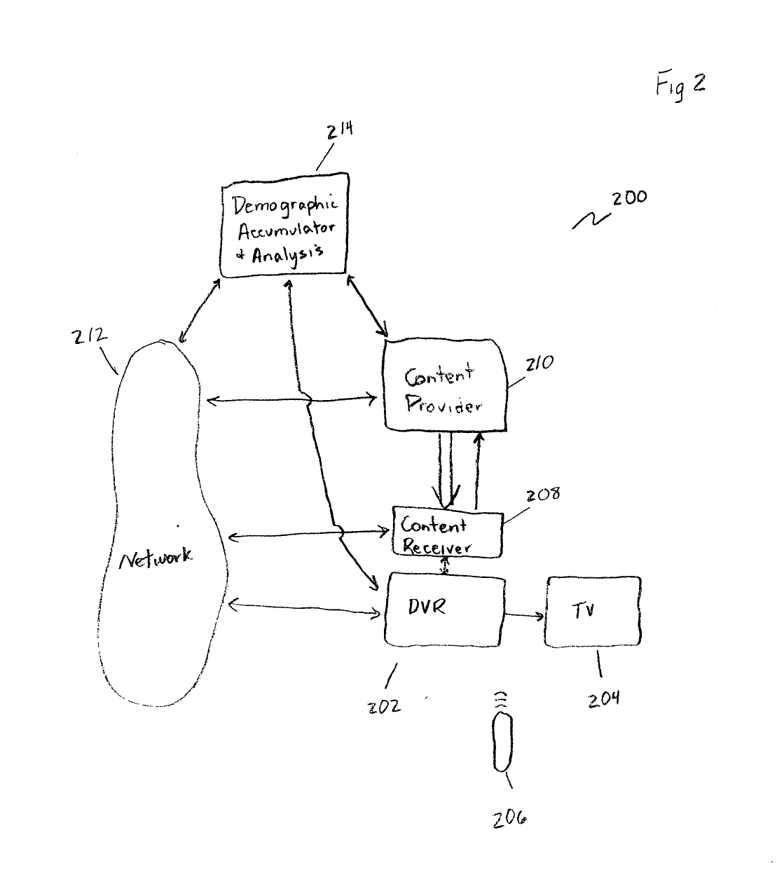

With reference to FIG. 2, a personalized distribution system 200 is shown. A media recorder 202 provides media content to a television 204. The media recorder 202 and television 204 may be controlled by user input to a remote control 206. The media recorder 202 receives content signals from a content receiver 208 in communication with a content provider 210. Demographic data may be collected to the media recorder or content receiver and provided to a demographic accumulator and analysis unit 214. The data may be provided directly or through a network 212.

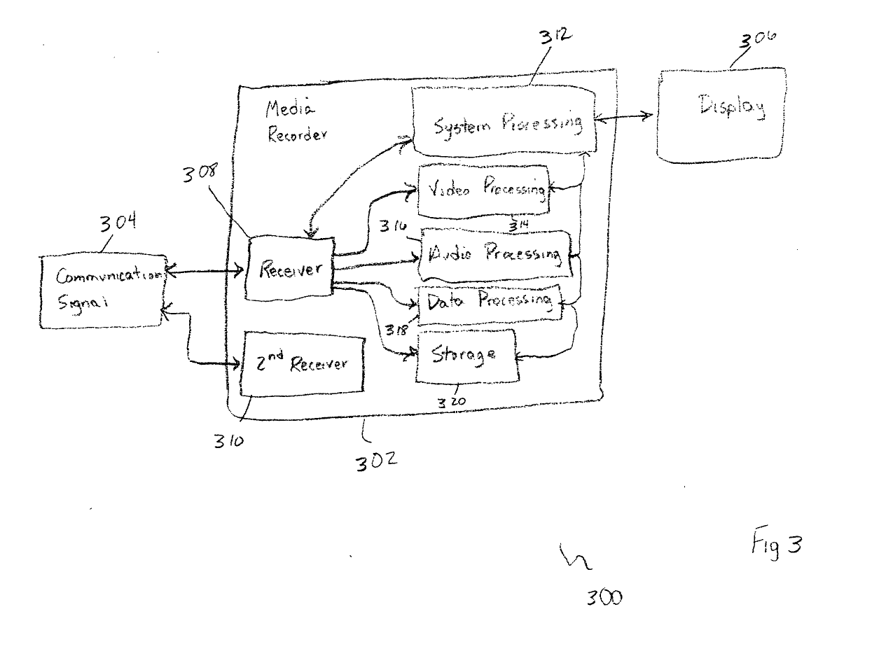

With reference to FIG. 3, a signal processing media recording system 300 is shown. A media recorder 302 receives communication signals 304. One or more receivers 308 and 310 may receive the communication signal and distribute content signals. System processing 312 controls the functions of the media recorder 302. Video processing 314 processes graphical data. Audio processing 316 processes audio data. Data processing 318 processes data. Data may be stored or retrieved from a storage device 320. Content may be rendered on display 306.

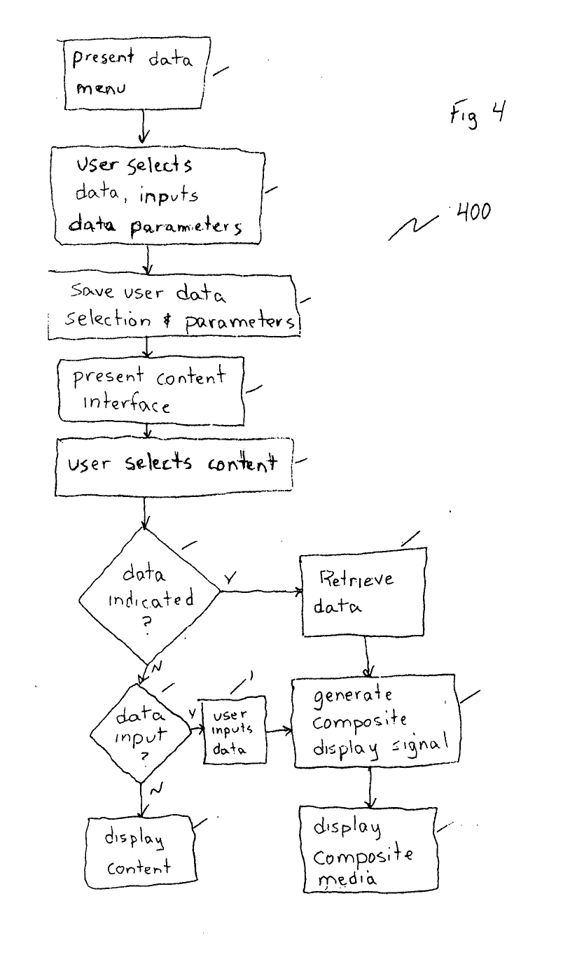

With reference to FIG. 4, a process for displaying composite media 400 is shown. A media system presents a data menu to a user at function block 402. The data menu may provide selection options to govern non-content display including thematic elements, borders, on-screen menus, photographs, wallpaper, sounds, video, dynamic content such as newsfeeds, stock prices, or any other type of data. The user makes selections on the data menu and may input data parameters at function block 404. The user data selection and parameters are stored at function block 406. The media recorder presents a content menu to a user at function block 408. The user makes a selection from the content menu at function block 410. The media system determines if the content selection is compatible with a data selection at decision block 412. If data is indicated at decision block 412, the process follows the YES path to retrieve the stored data at function block 414. A composite display signal is generated using the data and content at function block 416 and displayed at function block 418. If data is not indicated at decision block 412, the process follows the NO path to decision block 420 to determine if data may be input at this time. If data is needed, the process follows the YES path to function block 422 where the user inputs data. If no data is needed, the process follows the NO path to function block 424 where the content is displayed.

A content guide may support a content selection GUI that provides an easy process for generating and maintaining a list of favorite content selections. A content selection GUI for one or more user profiles may further assist in channel and content selection. Interactive television is currently available in varying forms. At the core of interactive television applications are the navigation applications provided to subscribers to assist in the discovery and selection of television programming. Currently available methods and systems for browsing and selecting broadcast or linear television are known as interactive program guides or electronic program guides. Current interactive program guides allow the subscriber to browse and select linear broadcast programming. These may include the ability to subset the broadcast linear program listing data by subject or type of programming. In addition to linear broadcast television, subscribers may now also be given opportunities to select from a list of programs that are not linear, but instead are provided on demand. Such technology is generally referred to as video-on-demand. The current schemes for browsing and selecting video-on-demand programs include the ability to select such programming from categories of programming. Due to advances in technologies such as data compression, system operators such as cable multiple system operators and satellite operators are able to send more and more broadcast channels and on-demand content over their systems.

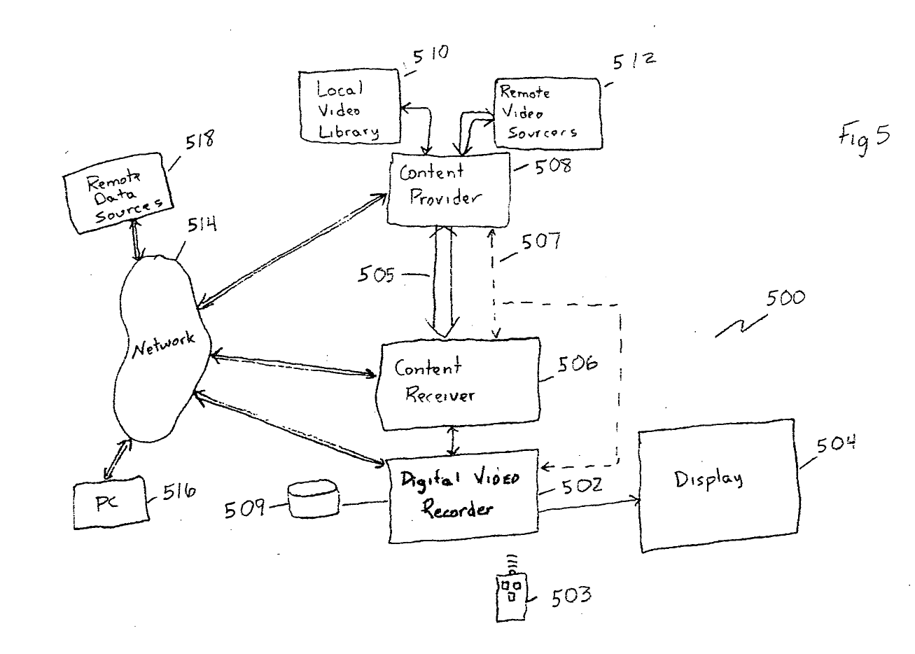

With reference to FIG. 5, a video distribution system 500 is shown. Content signal streams representing video, audio, images, television programming, movies, text, software or any other appropriate media content, are transmitted from content provider 508 to content receiver 506 over a communications network 505.

This in turn has prompted broadcast content providers and programmers to develop more and more channels and on-demand content offerings. Also, the addition of digital video recorder technology to set-top boxes now provide additional options for time-shifted viewing of broadcast television and increasing options for the storage of video-on-demand titles that have been purchased for viewing, or likely-to-purchase. The current television navigational structure is predicated on the numeric channel lineup where a channel's position is determined arbitrarily for each multiple-system-operator system and without regard for clustering content type or brand. To the TV viewer, this is also manifested in the grid-based navigational tools as they are generally structured in a time-by-channel grid format. As a navigational model, this has become outdated with the increasing number of channels, often 500 or more. The problem is further exacerbated with the addition of non-linear or non time-based on-demand and time-shifted content and other interactive applications such as games. With these increasing number of TV viewing options comes a complexity of navigating the options to find something to watch. There are generally two types of viewers.

Content provider 508 may typically be cable television providers, satellite television providers or other media broadcast source. The content receiver 506 typically provides authentication for conditional access content, descrambles, decodes or otherwise processes the received content signal streams. The content receiver 506 may be a set-top box such as a cable or satellite receiver. The content receiver 506 provides processed content signal streams to a media recorder 502.

One type of viewer knows the type of content they want to watch and are searching for an instance of that type of content. This is exemplified by a viewer who, wanting to watch an action film, wishes to browse available action films. The second type of viewer is one that has no specific notion of what they want to watch—they just want to find something interesting to them in a more impulse oriented manner. Televised content may be browsed using searching lists of content underneath category heading or browsing large lists or grids of data to find content, or typing in search criteria. These browse methods may be referred to as content search points. Content search points include interactive program guides and electronic program guides, movies-on-demand applications, text search, DVR recorded shows listings, and category applications. Menus and toolbars may allow one to jump to the various content search points. A large amount of content on the Digital TV service, the menus and toolbars themselves are becoming either long lists of specific content that are difficult to search, or short lists of general categories that do not provide quick access to specific needs. Thus the digital television including new content types and numerous viewing options require enhanced navigation for viewing television.

The media recorder may be implemented as a digital video recorder, as an independent unit or integrated into another media unit, a personal video recorder, a general purpose computer programmed to enable the functions of a media recorder, or any other appropriate recording system. In accordance with programming provided as inputs to remote control 503, usually in conjunction with interactive menus displayed on display 504, the media recorder records specified content signal streams on storage device 509.

Time shifting is the ability to perform various operations on a broadcast stream of data; i.e., a stream of data that is not flow-controlled. Example broadcast streams include digital television broadcasts, digital radio broadcasts, and Internet Protocol multicasts across a network, such as the Internet. A broadcast stream of data may include video data and/or audio data. Time shifting allows a user to “pause” a live broadcast stream of data without loss of data. Time shifting also allows a user to seek forward and backward through a stream of data, and play back the stream of data forward or backward at any speed. This time shifting is accomplished using a storage device, such as a hard disk drive, to store a received stream of data. The received stream of data is typically saved to a temporary file on the hard disk drive. The available storage space for the temporary file is typically limited such that the old content of the temporary file is discarded periodically (and possibly continuously) to release storage space for new data. Interactive television has already been deployed in various forms. An electronic program guide is one example, where a viewer is able to use the remote control to control the display of programming information such as TV show start times and duration, as well as brief synopses of TV shows.

The content receiver 506 may be physically integrated with the digital recorder 502. The digital video recorder 502 may pass live content signal streams to display 504. The media recorder 502 may record the live content signal stream on memory device 509 and decode the recorded live content signal stream for immediate playback. The media recorder 502 may decode and deliver recorded content signal streams to the display 504 on request. Exchanges of data may take place between digital video recorder 502 and content provider 508. The exchange of data may take place over communications network 505, back-channel 507, network 514 or any other appropriate communication channel.

The viewer can navigate around the electronic program guide, sorting the listings, or selecting a specific show or genre of shows to watch or tune to at a later time. Another example is a web-television interactive system, wherein web links, information about the show or story, shopping links, and so on are transmitted to the customer premises equipment through the vertical blanking interval of the TV signal. Other examples of interactive TV include television delivered via the Internet Protocol to a personal computer, where true interactivity can be provided, but typically only a subset of full interactivity is implemented. Full interactivity may include fully customizable screens and options that are integrated with the original television display, with interactive content being updated on the fly based on viewer preferences, demographics, other similar viewer's interactions, and the programming content being viewed.

Typically, media broadcast schedule data including the time, channel and title of televised broadcasts may be delivered from the content provider 508 to the digital video recorder 502. The media recorder may use the media broadcast schedule data to schedule recordings. The media broadcast schedule data may be retrieved from remote data sources 518 connected to network 514. The communication may be made through the video transmission connection via the content receiver 506 or along an alternate communication path 507 such as a telephone connection or a network connection, depending on the specific requirements and capabilities of the embodiment. A computer 516 may be communicably connected to media recorder 502.

The user interface for such a fully interactive system may be completely flexible and customizable, and may permit a variety of user data entry methods such as conventional remote controls, optical recognition of hand gestures, eye movements and other body movements, speech recognition, or in the case of disabled viewers, a wide range of assisted user interface technologies along with any other user data interface and input devices and methods. As used herein, “programs” include news shows, sitcoms, comedies, movies, commercials, talk shows, sporting events, on-demand videos, and any other form of television-based entertainment and information. Further, “recorded programs” include any of the aforementioned “programs” that have been recorded and that are maintained with a memory component as recorded programs, or that are maintained with a remote program data store. The “recorded programs” can also include any of the aforementioned “programs” that have been recorded and that are maintained at a broadcast center and/or at a head-end that distributes the recorded programs to subscriber sites and client devices. Conventional networking technologies may be used to facilitate the communications among the various systems. For example, the network communications may implement the Transmission Control Protocol/Internet Protocol (TCP/IP), and additional conventional higher-level protocols, such as the Hyper Text Transfer Protocol (HTTP) or File Transfer Protocol (FTP). Connection of media recorders to communication networks may allow the connected media recorders to share recorded content, utilize centralized or decentralized data storage and processing, respond to control signals from remote locations, periodically update local resources, provide access to network content providers, or enable other functions.

Computer 516 may be local to the media recorder, directly connected or connected through a local network. Computer 516 may be remote to the media recorder, connected through the Internet. Computer 516 may be used as an input device to the media recorder system. Computer 516 may be used as an output device for the media recorder system. Content provider 508 may access content files for distribution from local video libraries 510 or from remote video libraries 512. The video libraries 510 or 512 may be fiscally integral with the content providers or may be out-sourced.

The various communication networks employed may be implemented with different types of networks or portions of a network. The different network types may include: the conventional POTS telephone network, the Internet network, World Wide Web (WWW) network or any other suitable communication network. The POTS telephone network is a switched-circuit network that connects a client to a point of presence (POP) node or directly to a private server. The POP node and the private server connect the client to the Internet network, which is a packet-switched network using a transmission control protocol/Internet protocol (TCP/IP). The World Wide Web (WWW) network uses a hypertext transfer protocol (HTTP) and is implemented within the Internet network and supported by hypertext mark-up language (HTML) servers. Communications networks may be, include or interface to any one or more of, for instance, a cable network, a satellite television network, a broadcast television network, a telephone network, an open network such as the Internet, an intranet, a local area network (LAN), a wide area network (WAN), a metropolitan area network (MAN), a storage area network (SAN), a frame relay connection, an Advanced Intelligent Network (AIN) connection, a synchronous optical network (SONET) connection, a digital T1, T3, E1 or E3 line, Digital Data Service (DDS) connection, an ATM (Asynchronous Transfer Mode) connection, an FDDI (Fiber Distributed Data Interface), CDDI (Copper Distributed Data Interface) or other wired, wireless or optical connection.

Content provider 508 may receive or otherwise generate a listing of the video presentations available in the video libraries 510 and 512. The listings may include information regarding the video presentations as reference data for the viewer and to facilitate searching or organization of the video presentations to provide ease of selection. The listing may be provided to the digital video recorder 502 by any of the communication paths. A game processor 518 may be connected to media recorder 502, display 504 and audio 520. The audio rendering system 520 may be connected to the digital media recorder 502.

In embodiments, communications networks may include a comparatively high-capacity backbone link, such as a fiber optic or other link, connecting to a content provider, for transmission over which a carrier or other entity impose a per-megabyte or other metered or tariffed cost. A typical home network may be compatible with a high speed wired or wireless networking standard (e.g., Ethernet, HomePNA, 802.11a, 802.11b, 802.11g, 802.11g over coax, IEEE1394, etc.) although non-standard networking technologies may also be employed such as is currently available from companies such as Magis, FireMedia, and Xtreme Spectrum. A plurality of networking technologies may be employed with a network bridge as known in the art. A wired networking technology (e.g., Ethernet) may be used to connect fixed location devices, while a wireless networking technology (e.g., 802.11g) may be used to connect mobile devices. The media server may be also capable of being a receiving device for audio visual information and interfacing to a legacy device television. Networks that consolidate and distribute audiovisual information are also well known. Satellite and cable-based communication networks broadcast a significant amount of audio and audiovisual content.

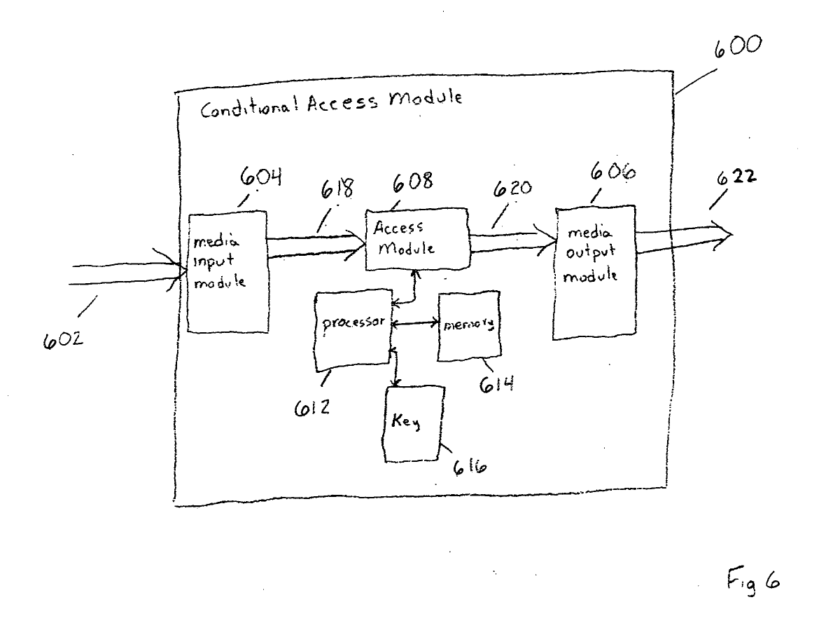

With reference to FIG. 6, a conditional access module 600 is shown. The conditional access module 600 receives a media signal 602 including an encoded media signal 618 at a media input module 604. An access module 608 receives the encoded media signal 618. If access to the media content represented by the encoded media signal 618 is authorized, the access module 608 decodes the encoded media signal 618 to generate decoded media signal 620.

Further, these networks also may be constructed to provide programming on demand, e.g., video-on-demand. In these environments a signal is broadcast, multicast, or unicast via a servicing network, and a set top box local to a delivery point receives, demodulates, and decodes the signal and places the audiovisual content into an appropriate format for playing on a delivery device, e.g., monitor and audio system. Recording of the audiovisual information for later playback has been recently introduced as an option for set-top-boxes. In such case, the set top box may include a hard drive that stores encoded audiovisual information for later playback. As used herein and in the appended claims, the term “display” will be understood to refer broadly to any video monitor or display device capable of displaying still or motion pictures including but not limited to a television. The term “audiovisual device” will be understood to refer broadly to any device that processes video and/or audio data including, but not limited to, television sets, computers, camcorders, set-top boxes, Personal Video Recorders (PVRs), video cassette recorders, digital cameras and the like. The term “audiovisual programming” will refer to any programming that can be displayed and viewed on a television set or other display device, including motion or still pictures with or without an accompanying audio soundtrack.

The decoded media signal 620 is delivered to a media output module 606 for further processing and distribution of output media signal 622. The access decision made by the access module 608 may be enacted, enforced or determined in conjunction with access processor 612. Access processor 612 typically executes applications, reads and stores data, and other necessary or desired functions of access memory 614. An access key input module 616 may accept user input or mechanical input such as a smartcard as an authentication input to access processor 612.

“Audiovisual programming” will also be defined to include audio programming with no accompanying video that can be played for a listener using a sound system of the television set or entertainment system. Audiovisual programming can be in any of several forms including, data recorded on a recording medium, an electronic signal being transmitted to or between system components or content being displayed on a television set or other display device. The various described components may be represented as modules comprising logic embodied in hardware or firmware. A collection of software instructions written in a programming language, such as, for example C++. A software module may be compiled and linked into an executable program, installed in a dynamic link library, or may be written in an interpretive language such as BASIC. It will be appreciated that software modules may be callable from other modules or from themselves, and/or may be invoked in response to detected events or interrupts. Software instructions may be embedded in firmware, such as an EPROM or EEPROM. It will be further appreciated that hardware modules may be comprised of connected logic units, such as gates and flip-flops, and/or may be comprised of programmable units, such as programmable gate arrays or processors. For example, in one embodiment, the functions of the compositor device 12 may be implemented in whole or in part by a personal computer or other like device. It is also contemplated that the various described components need not be integrated into a single box.

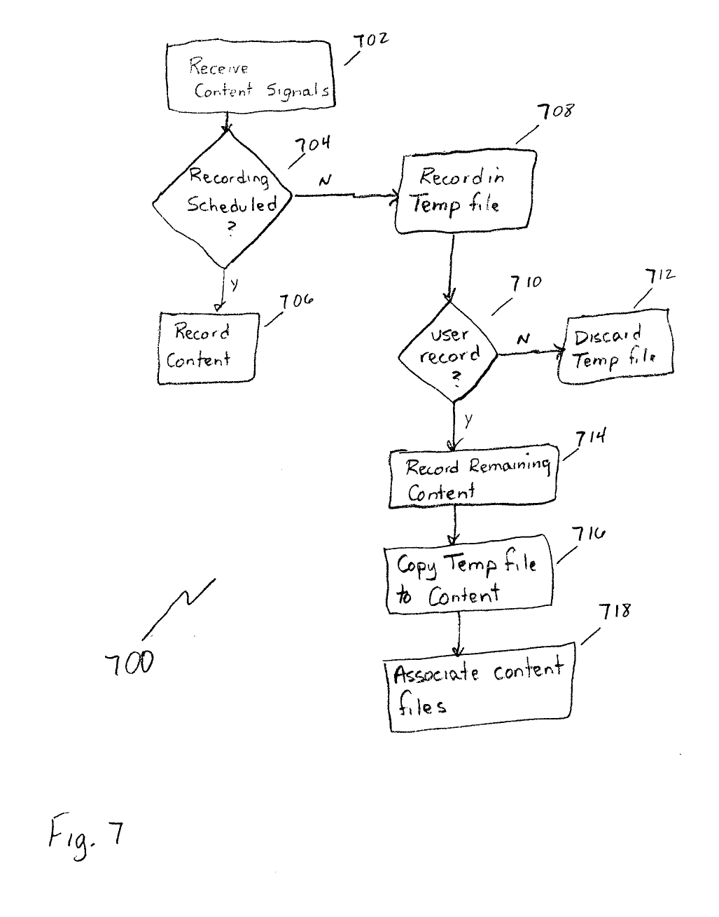

With reference to FIG. 7, a media recording process 700 is shown. A media recorder receives content signals at function block 702. The media recorder determines if a recording has been scheduled for the received content at decision block 704. If a recording is scheduled, the media recorder records the content at function block 706.

The components may be separated into several sub-components or may be separated into different devices that reside at different locations and that communicate with each other, such as through a wired or wireless network, or the Internet. Multiple components may be combined into a single component. It is also contemplated that the components described herein may be integrated into a fewer number of modules. One module may also be separated into multiple modules. As used herein, “high resolution” may be characterized as a video resolution that is greater than standard NTSC or PAL resolutions. Therefore, in one embodiment the disclosed systems and methods may be implemented to provide a resolution greater than standard NTSC and standard PAL resolutions, or greater than 720×576 pixels (414,720 pixels, or greater), across a standard composite video analog interface such as standard coaxial cable. Examples of some common high resolution dimensions include, but are not limited to: 800×600, 852×640, 1024×768, 1280×720, 1280×960, 1280×1024, 1440×1050, 1440×1080, 1600×1200, 1920×1080, and 2048×2048. In another embodiment, the disclosed systems and methods may be implemented to provide a resolution greater than about 800×600 pixels (i.e., 480,000 pixels), alternatively to provide a resolution greater than about 1024×768 pixels, and further alternatively to provide HDTV resolutions of 1280×720 or 1920×1080 across a standard composite video analog interface such as standard coaxial cable. Examples of high definition standards of 800×600 or greater that may be so implemented in certain embodiments of the disclosed systems and methods include, but are not limited to, consumer and PC-based digital imaging standards such as SVGA, XGA, SXGA, etc.

If no recording has been scheduled, the process follows the NO path and the received content is recorded in a temporary file at function block 708. If the user inputs a record command, the media recorder senses the input at decision block 710. If the user does not input a command the process follows the NO path and the temporary file is discarded at function block 712. If the user inputs a record command, the media recorder records the remaining content at function block 714. The temporary file is copied to a second content file at function block 716.

It will be understood that the forgoing examples are representative of exemplary embodiments only and that the disclosed systems and methods may be implemented to provide enhanced resolution that is greater than the native or standard resolution capability of a given video system, regardless of the particular combination of image source resolution and type of interface. Media content may be delivered to homes via cable networks, satellite, terrestrial, and the Internet. The content may encrypted or otherwise scrambled prior to distribution to prevent unauthorized access. Conditional access systems reside with subscribers to decrypt the content when the content is delivered. Media systems implement conditional access policies that specify when and what content the viewers are permitted to view based on their subscription package or other conditions. In this manner, the conditional access systems ensure that only authorized subscribers are able to view the content. Conditional access systems may support remote control of the conditional access policies. This allows content providers to change access conditions for any reason, such as when the viewer modifies subscription packages. Conditional access systems may be implemented as a hardware based system, a software based system, a smartcard based system, or hybrids of these systems. In the hardware based systems, the decryption technologies and conditional policies are implemented using physical devices. The hardware-centric design is considered reasonably reliable from a security standpoint, because the physical mechanisms can be structured so that they are difficult to attack. The content files are associated at function block 718.

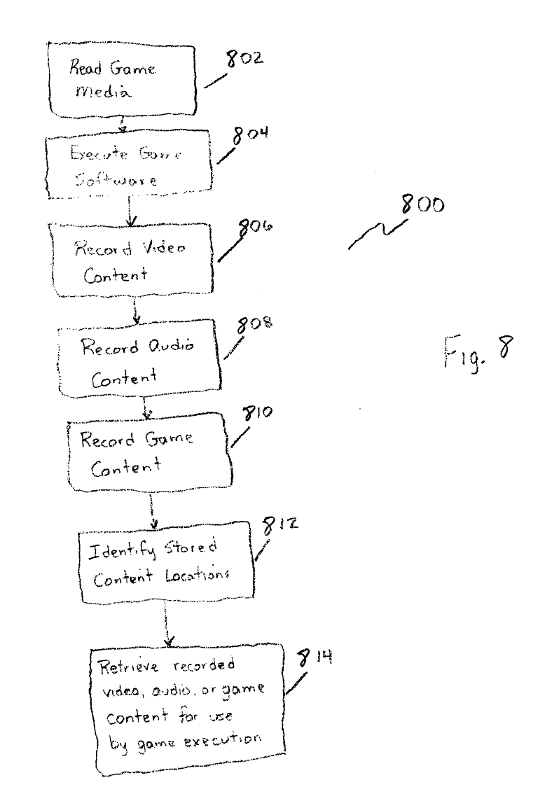

With reference to FIG. 8, a game content process 800 is shown. A game machine reads game media at function block 802. The game machine executes game software at function block 804. Video content is recorded at function block 806.

However, the hardware solution has drawbacks in that the systems may not be easily serviced or upgraded and the conditional access policies are not easily renewable. Software-based solutions, such as digital rights management designs, rely on obfuscation for protection of the decryption technologies. With software-based solutions, the policies are easy and inexpensive to renew, but such systems can be easier to compromise in comparison to hardware-based designs. Smartcard based systems rely on a secure microprocessor. Smart cards can be inexpensively replaced, but have proven easier to attack than the embedded hardware solutions. During playback operation, an instruction may be received to accelerate—“fast-forward”—the effective frame rate of the recorded content signal stream being played. The apparent increase in frame rate is generally accomplished by periodically reducing the number of content frames that are displayed. Typically, multiple acceleration rates may be enabled, providing display at multiple fast-forward speeds. An accelerated display of a video signal recorded at a standard rate, such as thirty frames per second, may display the video at effectively higher frame rates although the actual rate the frames are displayed does not change. For example, where a digital video recorder 108 includes three fast-forward settings, the fast-forward frame rates may appear to be 60 frames per second, 90 frames per second and 120 frames per second. The remote control used to control a media recorder may be a personal remote, where data sent from the remote control to the digital video recorder identifies the person associated with the remote control device. Where an authentication process has been used to authenticate the personal remote, the use of the personal remote could provide a legally binding signature for interactions, including any commercial transactions.

Audio content is recorded at function block 808. Game content is recorded at function block 810. The stored content locations are identified to the game machine at function block 812. The game machine retrieves recorded video, audio or game content for use by the game execution at function block 814.

In accordance with an embodiment, the personal remote could be a cellular telephone, personal digital assistant, or any other appropriate personal digital device. An integrated personal remote with a microphone and camera, such as might be found on a cellular phone, could be used for live interaction through the media recorder system with product representatives or other interactions. A personal remote could communicate wirelessly with the media system using I/R, radio communications, etc. A docking station could be used to directly connect the portable device to the system. An interface port, such as a USB port, may be built into the portable communication device for direct connection to a digital video recorder, content receiver or any networked device. Where product viewings, purchases and identity are associated and logged, demographic and habit patterns could be provided to advertisers, product suppliers and other interested parties. Using this data collection, personalized recommendations could be provided to the identified user. In accordance with the practices of persons skilled in the art of computer programming, there are descriptions referring to symbolic representations of operations that are performed by a computer system or a like electronic system. Such operations are sometimes referred to as being computer-executed. It will be appreciated that operations that are symbolically represented may include the manipulation by a processor, such as a central processing unit, of electrical signals representing data bits and the maintenance of data bits at memory locations such as in system memory, as well as other processing of signals. The memory locations where data bits are maintained may be physical locations that have particular electrical, magnetic, optical, or organic properties corresponding to the data bits. Thus, the term “server” may be understood to include any electronic device that contains a processor, such as a central processing unit.

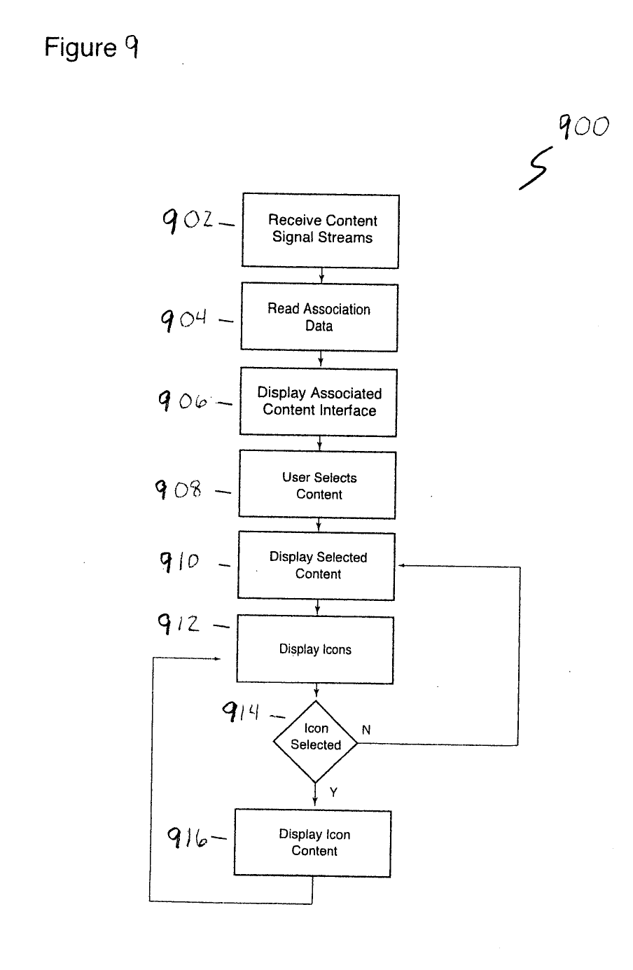

With reference to FIG. 9, a flowchart of a layered content presentation process 900 is shown. At function block 902, the content receiver receives content signal streams. The content receiver reads associational data from the content signal streams at function block 904. An associated content interface is generated and displayed at function block 906.

When implemented in software, processes may be embodied essentially as code segments to perform the necessary tasks. The program or code segments may be stored in a processor readable medium or transmitted by a computer data signal embodied in a carrier wave over a transmission medium or communication link. The “processor readable medium” may include any medium that can store or transfer information. Examples of the processor readable medium include an electronic circuit, a semiconductor memory device, a ROM, a flash memory or other non-volatile memory, a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc. Telecommunication systems distribute content objects. Various systems and methods utilize a number of content object entities that can be sources and/or destinations for content objects. A combination of abstraction and distinction engines can be used to access content objects from a source of content objects, format and/or modify the content objects, and redistribute the modified content object to one or more content object destinations. In some cases, an access point is included that identifies a number of available content objects, and identifies one or more content object destinations to which the respective content objects can be directed.

A user selects content using the interface at function block 908. The selected content signal stream is displayed at function block 910. Icons may be displayed as an overlay interface on the content signal stream display at function block 912. The process determines if an icon has been selected at decision block 914. If no icon has been selected, the NO path is followed and the display of selected content continues. If an icon is selected, the process follows the YES path to display the content associated with the selected icon at function block 916. Icons are displayed over the content at function block 912.

Such systems and methods can be used to select a desired content object, and to select a content object entity to which the content object is directed. In addition, the systems and methods can be used to modify the content object as to format and/or content. For example, the content object may be reformatted for use on a selected content object entity, modified to add additional or to reduce the content included in the content object, or combined with one or more other content objects to create a composite content object. This composite content object can then be directed to a content object destination where it can be either stored or utilized. Abstraction and distinction processes may be performed on content objects. These systems may include an abstraction engine and a distinction engine. The abstraction engine may be communicably coupled to a first group of content object entities, and the distinction engine may communicably coupled to second group of content object entities. The two groups of content object entities are not necessarily mutually exclusive, and in many cases, a content object entity in one of the groups is also included in the other group. The first of the groups of content object entities may include content objects entities such as an appliance control system, a telephone information system, a storage medium including video objects, a storage medium including audio objects, an audio stream source, a video stream source, a human interface, the Internet, and an interactive content entity. The second group of content object entities may include content object entities such as an appliance control system, a telephone information system, a storage medium including video objects, a storage medium including audio objects, a human interface, the Internet, and an interactive content entity.

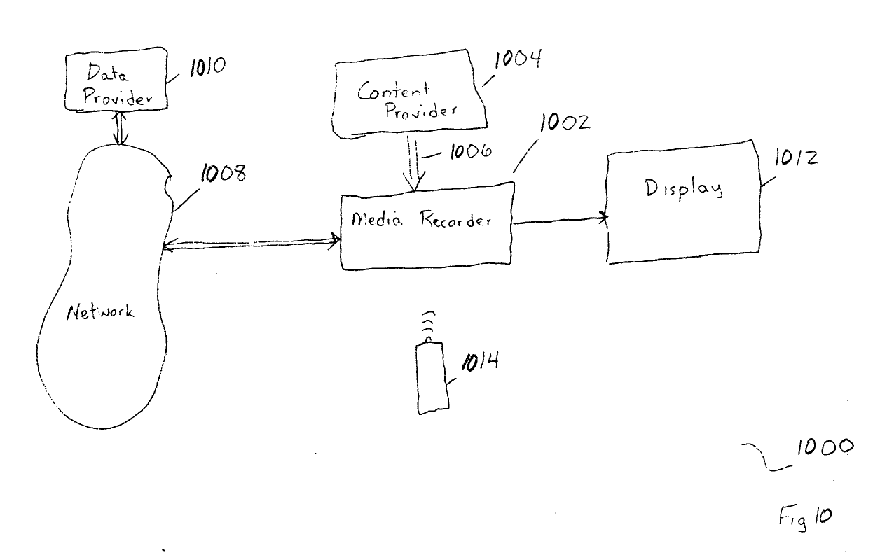

With reference to FIG. 10, a composite content display system 1000 is shown. A media recorder 1002 receives and records content from a content provider 1004 over communication network 1006. The media recorder 1002 may also receive data from a data provider 1010 over network 1008. The content and data may be provided by the media recorder 1002 for simultaneous display on video rendering device 1012. Selection of the content, data and the format for simultaneous display may be determined based on input commands from user input device 1014.

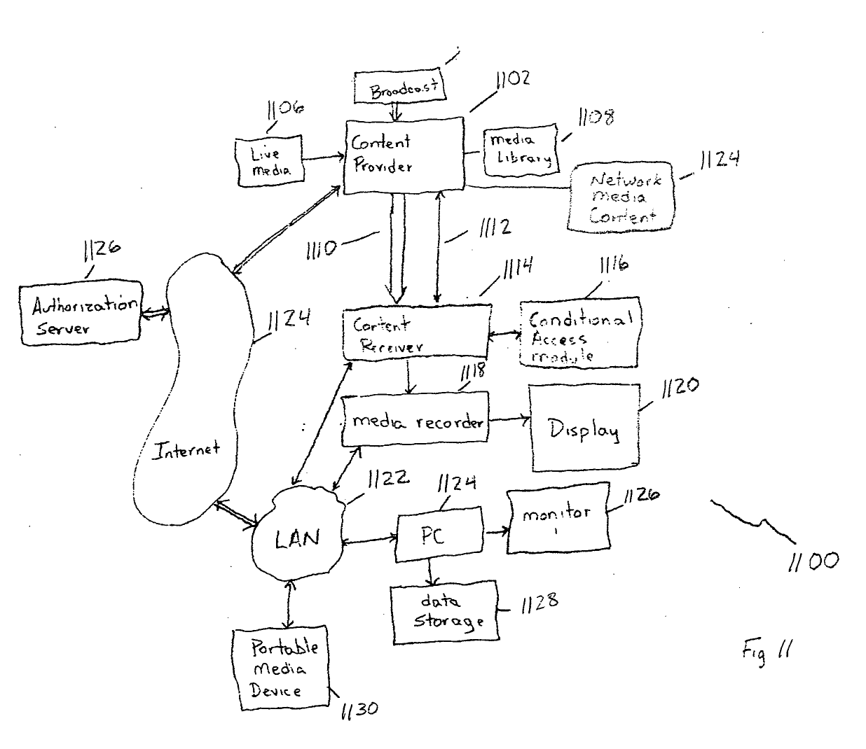

With reference to FIG. 11, a network media transfer system 1100 is shown. A content provider 1102 delivers media to a content receiver 1114 over a communication system 1110.

In some instances, two or more of the content object entities are maintained on separate partitions of a common database. In such instances, the common database can be partitioned using a content based schema, while in other cases the common database can be partitioned using a user based schema. In particular instances, the abstraction engine may be operable to receive a content object from one of the groups of content object entities, and to form the content object into an abstract format. As just one example, this abstract format can be a format that is compatible at a high level with other content formats. In other instances, the abstraction engine is operable to receive a content object from one of the content object entities, and to derive another content object based on the aforementioned content object. Further, the abstraction engine can be operable to receive yet another content object from one of the content object entities and to derive an additional content object there from. The abstraction engine can then combine the two derived content objects to create a composite content object. In some cases, the distinction engine accepts the composite content object and formats it such that it is compatible with a particular group of content object entities. In yet other instances, the abstraction engine is operable to receive a content object from one group of content object entities, and to form that content object into an abstract format. The distinguishing engine can then conform the abstracted content object with a standard compatible with a selected one of another group of content object entities.

The content provider may deliver live media content 1106, broadcast media content 1104, stored media content 1108, network media content 1124, or any other appropriate content. The content receiver 1114 may communicate with content provider 1102 using a backchannel 1112 such as a telephone connection, network connection or any other appropriate communication channel. A backchannel 1112 is often used when communication system 1110 is unidirectional, such as in a satellite broadcast system. Content receiver 1114 may be connected to or otherwise implement a conditional access module 1116. Conditional access module 1116 determines authorization and decodes encoded media signals accordingly.

In some other instances, the systems include an access point that indicates a number of content objects associated with one group of content object entities, and a number of content objects associated with another group of content object entities. The access point indicates from which group of content object entities a content object can be accessed, and a group of content object entities to which the content object can be directed. Methods for utilizing content objects may include accessing a content object from a content object entity; abstracting the content object to create an abstracted content object; distinguishing the abstracted content object to create a distinguished content object, and providing the distinguished content object to a content object entity capable of utilizing the distinguished content object. In some cases, the methods further include accessing yet another content object from another content object entity, and abstracting that content object entity to create another abstracted content object entity. The two abstracted content object entities can be combined to create a composite content object entity. In one particular case, the first abstracted content object may be a video content object and the second abstracted content object may be an audio content object. Thus, the composite content object includes audio from one source, and video from another source. Further, in such a case, abstracting the video content object can include removing the original audio track from the video content object prior to combining the two abstracted content objects. As yet another example, the first abstracted content object can be an Internet object, while the other abstracted content object is a video content object.

A media recorder 1118 may receive media signals from content receiver 1114. The media recorder 1118 may store the media signals to data storage. The media recorder may deliver media signals to display 1120 for viewing. A local area network 1122 may connect the content receiver 1114 and the media recorder 1118 to other local devices as well as the Internet 1124.

In other cases, the methods can further include identifying a content object associated with one group of content object entities that has expired, and removing the identified content object. Other cases include querying a number of content object entities to identify one or more content objects accessible via the content object entities, and providing an access point that indicates the identified content objects and one or more content object entities to which the identified content objects can be directed. Methods may include accessing content objects within a customer premises. Such methods may include identifying content object entities within the customer premises, and grouping the identified content objects into two or more groups of content object entities. At least one of the groups of content object entities may include sources of content objects, and at least another of the groups of content object entities may include destinations of content objects. The methods may include providing an access point that indicates the at least one group of content object entities that can act as content object sources, and at least another group of content object entities that can act as content object destinations. In some cases, the methods further include mixing two or more content objects from the first plurality of content object entities to form a composite content object, and providing the composite content object to a content object entity capable of utilizing it. In other cases, the methods further include eliminating a portion of a content object accessed from one group of content object entities and providing this reduced content object to another content object entity capable of utilizing the reduced content object entity.

An authorization server 1126 may provide authorization services to the media recorder 1118. A personal computer 1124 may be connected to the local area network 1122. The personal computer 1124 may received media signals from media recorder 1118. The personal computer 1124 may display the received media signals on a monitor 1126.

A variety of digital video compression techniques have arisen to transmit or to store a video signal with a lower data rate or with less storage space. Such video compression techniques include international standards, such as H.261, H.263, H.263+, H.263++, H.264, MPEG-1, MPEG-2, MPEG-4, and MPEG-7. These compression techniques achieve relatively high compression ratios by discrete cosine transform (DCT) techniques and motion compensation (MC) techniques, among others. Such video compression techniques permit video data streams to be efficiently carried across a variety of digital networks, such as wireless cellular telephony networks, computer networks, cable networks, via satellite, and the like, and to be efficiently stored on storage mediums such as hard disks, optical disks, Video Compact Discs (VCDs), digital video discs (DVDs), and the like. The encoded data streams are decoded by a video decoder that is compatible with the syntax of the encoded data stream. For relatively high image quality, video encoding can consume a relatively large amount of data. However, the communication networks that carry the video data can limit the data rate that is available for encoding. For example, a data channel in a direct broadcast satellite (DBS) system or a data channel in a digital cable television network typically carries data at a relatively constant bit rate (CBR) for a programming channel. In addition, a storage medium, such as the storage capacity of a disk, can also place a constraint on the number of bits available to encode images. As a result, a video encoding process often trades off image quality against the number of bits used to compress the images. Moreover, video encoding can be relatively complex. For example, where implemented in software, the video encoding process can consume relatively many CPU cycles.

The personal computer 1124 may save the media signals on a data storage device 1128 such as a hard drive or write-able optical disc. A portable media device 1130 may be connected to the media recorder 1118 by local area network 1122.

Further, the time constraints applied to an encoding process when video is encoded in real time can limit the complexity with which encoding is performed, thereby limiting the picture quality that can be attained. One conventional method for rate control and quantization control for an encoding process is described in Chapter 10 of Test Model 5 (TM5) from the MPEG Software Simulation Group (MSSG). TM5 suffers from a number of shortcomings. An example of such a shortcoming is that TM5 does not guarantee compliance with the Video Buffer Verifier (VBV) requirement. As a result, overrunning and underrunning of a decoder buffer can occur, which undesirably results in the freezing of a sequence of pictures and the loss of data. In accordance with the MPEG-2 standard, video data may be compressed based on a sequence of groups of pictures (GOPs), made up of three types of picture frames—intra-coded picture frames (“I-frames”), forward predictive frames (“P-frames”) and bilinear frames (“B-frames”). Each GOP may, for example, begin with an I-frame which is obtained by spatially compressing a complete picture using discrete cosine transform (DCT). As a result, if an error or a channel switch occurs, it is possible to resume correct decoding at the next I-frame. The GOP may represent additional frames by providing a much smaller block of digital data that indicates how small portions of the I-frame, referred to as macroblocks, move over time. An I-frame is typically followed by multiple P- and B-frames in a GOP.

The portable media device 1130 may receive media signals from media recorder 1118 for viewing on an integrated display. The authorization server 1126 may be used to authorize the distribution or playback of media signals sent from the media recorder 1118 to other devices.

Thus, for example, a P-frame occurs more frequently than an I-frame by a ratio of about 3 to 1. A P-frame is forward predictive and is encoded from the I- or P-frame that precedes it. A P-frame contains the difference between a current frame and the previous I- or P-frame. A B-frame compares both the preceding and subsequent I- or P-frame data. The B-frame contains the average of matching macroblocks or motion vectors. Because a B-frame is encoded based upon both preceding and subsequent frame data, it effectively stores motion information. Thus, MPEG-2 achieves its compression by assuming that only small portions of an image change over time, making the representation of these additional frames extremely compact. Although GOPs have no relationship between themselves, the frames within a GOP have a specific relationship which builds off the initial I-frame. The compressed video and audio data are carried by continuous elementary streams, respectively, which are broken into access units or packets, resulting in packetized elementary streams (PESs). These packets are identified by headers that contain time stamps for synchronizing, and are used to form MPEG-2 transport streams. For digital broadcasting, multiple programs and their associated PESs are multiplexed into a single transport stream. A transport stream has PES packets further subdivided into short fixed-size data packets, in which multiple programs encoded with different clocks can be carried. A transport stream not only comprises a multiplex of audio and video PESs, but also other data such as MPEG-2 program specific information (sometimes referred to as metadata) describing the transport stream. The MPEG-2 metadata may include a program associated table (PAT) that lists every program in the transport stream. Each entry in the PAT points to an individual program map table (PMT) that lists the elementary streams making up each program. Some programs are open, but some programs may be subject to conditional access (encryption) and this information is also carried in the MPEG-2 transport stream, possibly as metadata. The aforementioned fixed-size data packets in a transport stream each carry a packet identifier (PID) code.

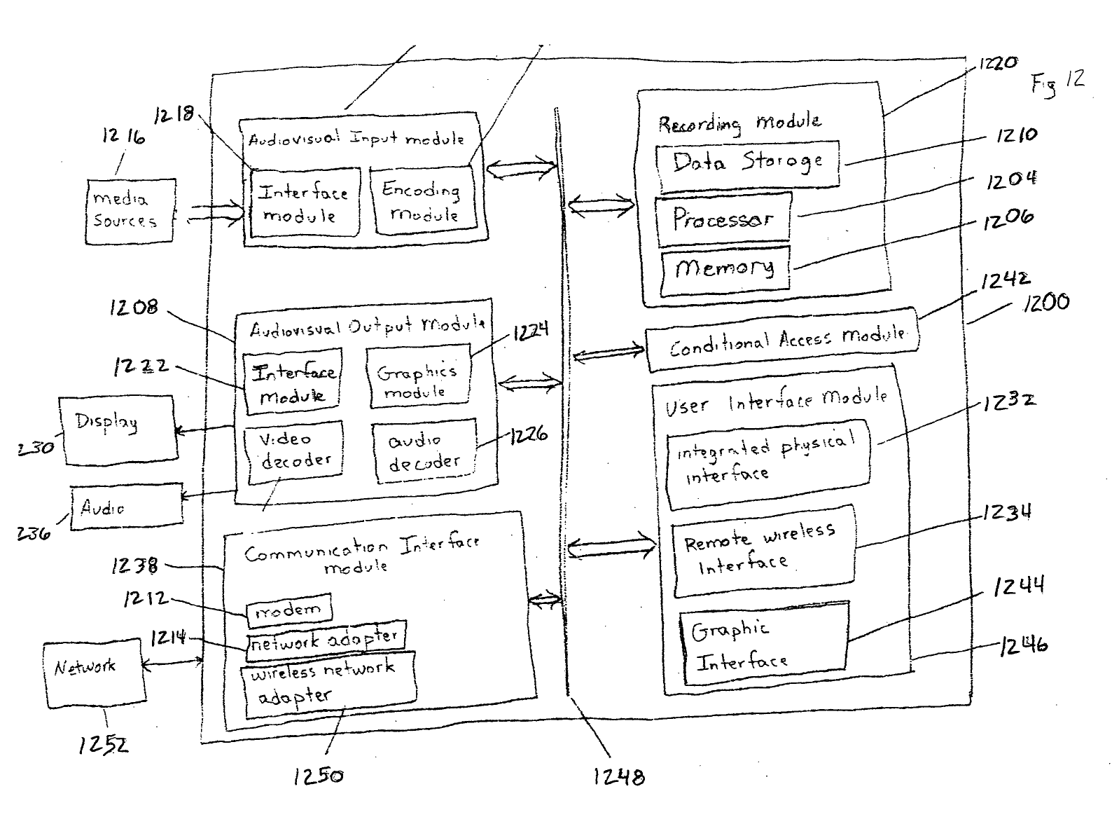

With reference to FIG. 12, a media recorder 1200 in accordance with a disclosed embodiment is shown. The media recorder 1200 may include an audiovisual input module 1202. The audiovisual input module 1202 may receive media signals from a content provider 1216 or other media sources.

Packets in the same elementary streams all have the same PID, so that a decoder can select the elementary stream(s) it needs and reject the remainder. Packet-continuity counters may be implemented to ensure that every packet that is needed to decode a stream is received. Content signals may be or include any one or more video signal formats, for instance NTSB, PAL, Windows AVI, Real Video, MPEG-2 or MPEG-4 or other formats, digital audio for instance in .WAV, MP3 or other formats, digital graphics for instance in .JPG, .BMP or other formats, computer software such as executable program files, patches, updates, transmittable applets such as ones in Java or other code, or other data, media or content. Cable television and satellite television presents users with hundreds of channels available for viewing. The number of channels may increase significantly, particularly with the continuing evolution of television. The digital televisions reflect advances of television technology and computer technology, introducing programmability, expanded functions, communication with other devices including computers or printers. Televisions may provide thousands of channels, as well as offering various different types of content such as video on demand content, near video on demand content, audio on demand content, live content, Internet content, personal video recorder content, digital video recorder content, media content, etc. “Content” may refer to various different sources of content, such as television channels and these aforementioned different types of content. With such a large amount of content and an increase in the types and amount of content, each with its own navigational graphical user interface, a seamless and integrated content selection method supports an intelligent, user-friendly and intuitive experience using appropriate navigational graphical user interface or content selection GUI to assist users in content selection.

The media recorder may include an audiovisual output module 1208. The audiovisual output module 1208 may output media signals to a display 1230, an audio rendering device 1236 or other appropriate output devices. The media signals may be processed, stored or transferred by a media recording module 1220 including a media recorder processor 1204 and processing memory 1206. Data storage medium 1210 is typically used to stored the recorded media data. The media recorder 1200 may communicate with other components or systems either directly or through a network 1252 with a communication interface module 1238. The communication interface module 1238 may implement a modem 1212, network interface 1214, wireless interface 1250 or any other suitable communication interface. The elements of the media recorder 1200 may be interconnected by a conventional bus architecture 1248. Generally, the processor 1204 executes instructions such as those stored in processing memory 1208 to provide functionality. Processing memory 1208 may include dynamic memory devices such as RAM or static memory devices such as ROM and/or EEPROM. The processing memory 1208 may store instructions for boot up sequences, system functionality updates, or other information. Communication interface module 1238 may include a network interface 1214. The network interface 1214 may be any conventional network adapter system. Typically, network interface 1214 may allow connection to an Ethernet network 1252. The network interface 1214 may connect to a home network, to a broadband connection to a WAN such as the Internet or any of various alternative communication connections. Communication interface module 1238 may include a wireless network interface 1250. Typically, wireless network interface 1250 permits the media recorder to connect to a wireless communication network. A user interface module 1246 provides user interface functions. The user interface module 1246 may include integrated physical interfaces 1232 to provide communication with input devices such as keyboards, touch-screens, card readers or other interface mechanisms connected to the media recorder 1200. The user may control the operation of the media recorder 1200 through control signals provided on the exterior of the media recorder 1200 housing through integrated user input interface 1232. The media recorder 1200 may be controlled using control signals originating from a remote control, which are received through the remote signals interface 1234, in a conventional fashion. Other conventional electronic input devices may also be provided for enabling user input to media recorder 1200, such as a keyboard, touch screen, mouse, joy stick, or other device. These devices may be built into media recorder 1200 or associated hardware (e.g., a video display, audio system, etc.), be connected through conventional ports (e.g., serial connection, USB, etc.), or interface with a wireless signal receiver (e.g., infrared, Bluetooth.TM., 802.11b, etc.). A graphical interface module 1244 provides graphical interfaces on a display to permit user selections to be entered. The audiovisual input module 1202 receives input through an interface module 1218 that may include various conventional interfaces, including coaxial RF/Ant, S-Video, component audio/video, network interfaces, and others. The received signals can originate from standard NTSC broadcast, high definition television broadcast, standard cable, digital cable, satellite, Internet, or other sources, with the audiovisual input module 1202 being configured to include appropriate conventional tuning and decoding functionality. The media recorder 1200 may also receive input from other devices, such as a set top box or a media player (e.g., VCR, DVD player, etc.). For example, a set top box might receive one signal format and outputs an NTSC signal or some other conventional format to the media recorder 1200. The functionality of a set top box, media player, or other device may be built into the same unit as the media recorder 1200 and share one or more resources with it. The audiovisual input module 1202 may include an encoding module 1236. The encoding modules 1236 convert signals from a first format (e.g., analog NTSC format) into a second format (e.g., MPEG 2, etc.) so that the signal converted into the second format may be stored in the memory 1208 or the data storage medium 1210 such as a hard disk. Typically, content corresponding to the formatted data stored in the data storage medium 1210 may be viewed immediately, or at a later time. Additional information may be stored in association with the media data to manage and identify the stored programs. Other embodiments may use other appropriate types of compression. The audiovisual output module 1208 may include an interface module 1222, a graphics module 1224, video decoder 1228 and audio decoder 1226. The video decoder 1228 and audio decoder 1226 may be MPEG decoders. The video decoder 1228 may obtain encoded data stored in the data storage medium 1210 and convert the encoded data into a format compatible with the display device 1230. Typically the NTSC format may be used as such signals are displayed by a conventional television set. The graphics module 1224 may receive guide and control information and provides signals for corresponding displays, outputting them in a compatible format. The audio decoder 1226 may obtain encoded data stored in the data storage medium 1210 and converts the encoded data into a format compatible with an audio rendering device 1236. The media recorder 1200 may process guide information that describes and allows navigation among content from a content provider at present or future times. The guide information may describe and allow navigation for content that has already been captured by the media recorder 1200. Guides that display this type of information may generally be referred to as content guides. A content guide may include channel guides and playback guides. A channel guide may display available content from which individual pieces of content may be selected for current or future recording and viewing. In a specific case, the channel guide may list numerous broadcast television programs, and the user may select one or more of the programs for recording. The playback guide displays content that is stored or immediately storable by the media recorder 1200. Other terminology may be used for the guides. For example, they may be referred to as programming guides or the like. The term content guide is intended to cover all of these alternatives. The media recorder 1200 may also be referred to as a digital video recorder or a personal video recorder. Although certain modular components of a media recorder 1200 are shown in FIG. 12, the present invention also contemplates and encompasses units having different features. For example, some devices may omit a telephone line modem, instead using alternative conduits to acquire guide data or other information used in practicing the present invention. Additionally, some devices may add features such as a conditional access module 1242, such as one implementing smart card technology, which works in conjunction with certain content providers or broadcasters to restrict access to content. Additionally, although this embodiment and other embodiments of the present invention are described in connection with an independent media recorder device, the descriptions may be equally applicable to integrated devices including but not limited to cable or satellite set top boxes, televisions or any other appropriate device capable of including modules to enable similar functionality.

A content selection GUI is a user interface that presents content descriptive information in a graphical form to enable the user to navigate through the information, irrespective of the source of content or its type. Electronic content guides display available channels in a time-based schedule grid. Electronic guides may report content description information for a single type of content. This content description information may include, but is not limited to, scheduling information, title, rating, names of participating actors, or any other information associated with the content. Electronic guides typically require input from a user to create a favorites list.

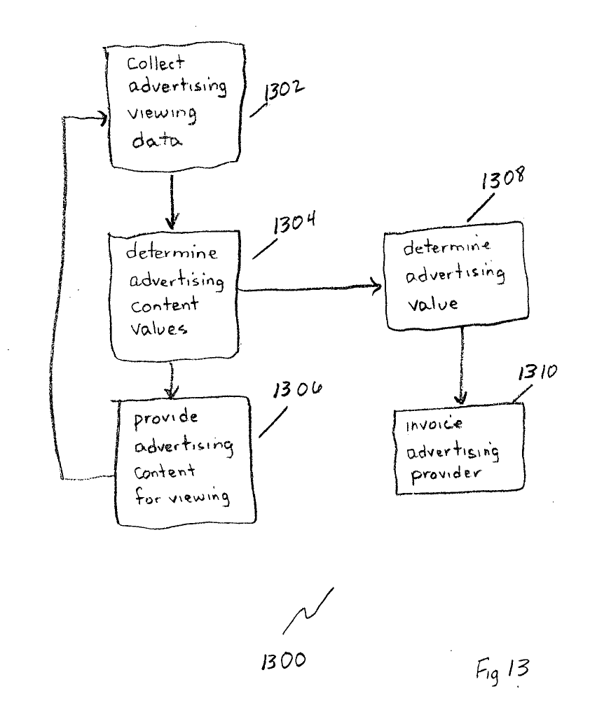

With reference to FIG. 13, a advertising process 1300 is shown. A media recorder collected advertising viewing data at function block 1302. Advertising content values are determined at function block 1304. Advertising values are determined at function block 1308. The advertising provider is invoiced accordingly at function block 1310. Further advertising content is provided for viewing at function block 1306.

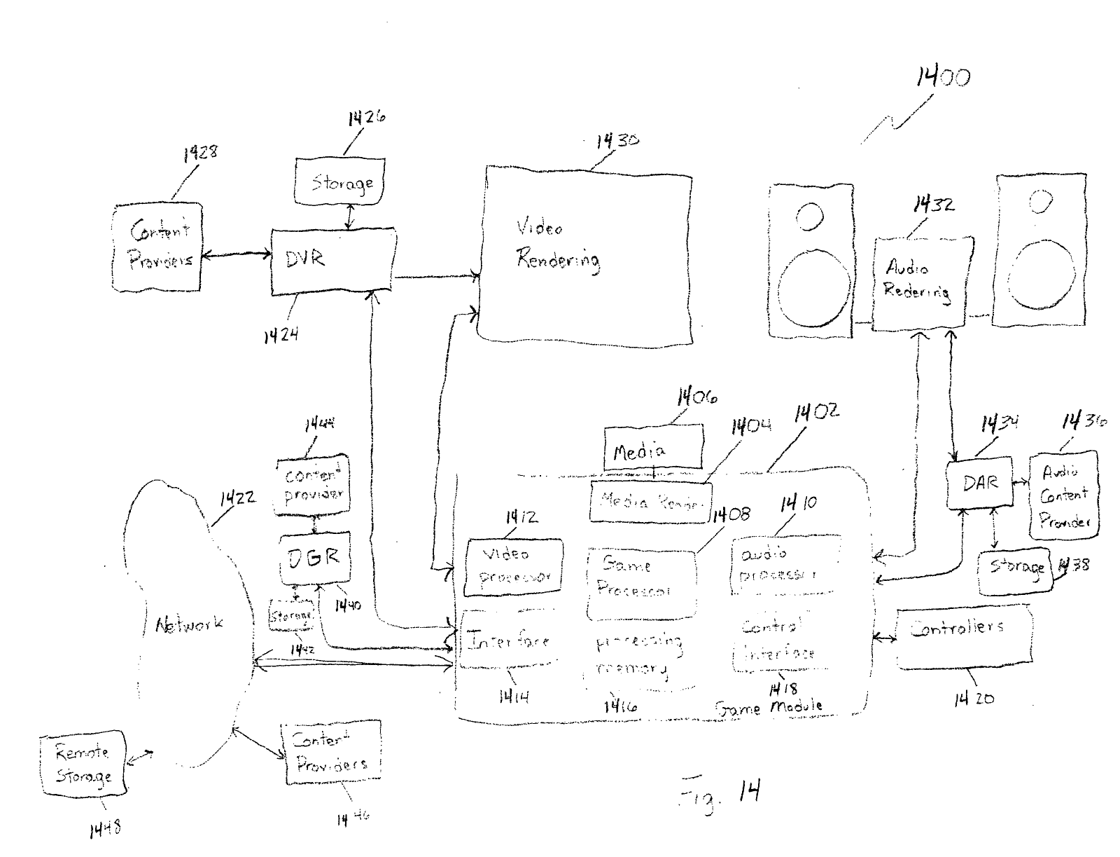

With reference to FIG. 14, a game module system 1400 is shown. A game module 1402 may include a media reader 1404 used in conjunction with media 1406. A game processor 1408 typically processes the gaming functions. A video processor 1412 typically processes the video signal generated for the game functions and provides them to video rendering system 1430. An audio processor 1410 typically processes the audio signal generated for the game functions and provides them to audio rendering system 1432. A control interface 1418 provides an interface between the game processor 1408 and the controllers 1420. Processing memory 1416 may be used by the processors 1412, 1408 and 1410 for processing. A digital interface 1414 provides an interface to network 22. Network 1422 may provide connection to content providers 1446 and remote storage 1448. A media recorder 1424 may be connected to the game module 1402 using interface 1414. The media recorder may receive content from a content provider 1428. Selected content may be recorded on storage 1426. An audio recorder 1434 may receive audio content from an audio content provider 1436. The audio recorder may record selected audio content using storage 1438. A game recorder 1440 may receive game content from game content provider 1444. Selected game content may be stored on storage 1442.

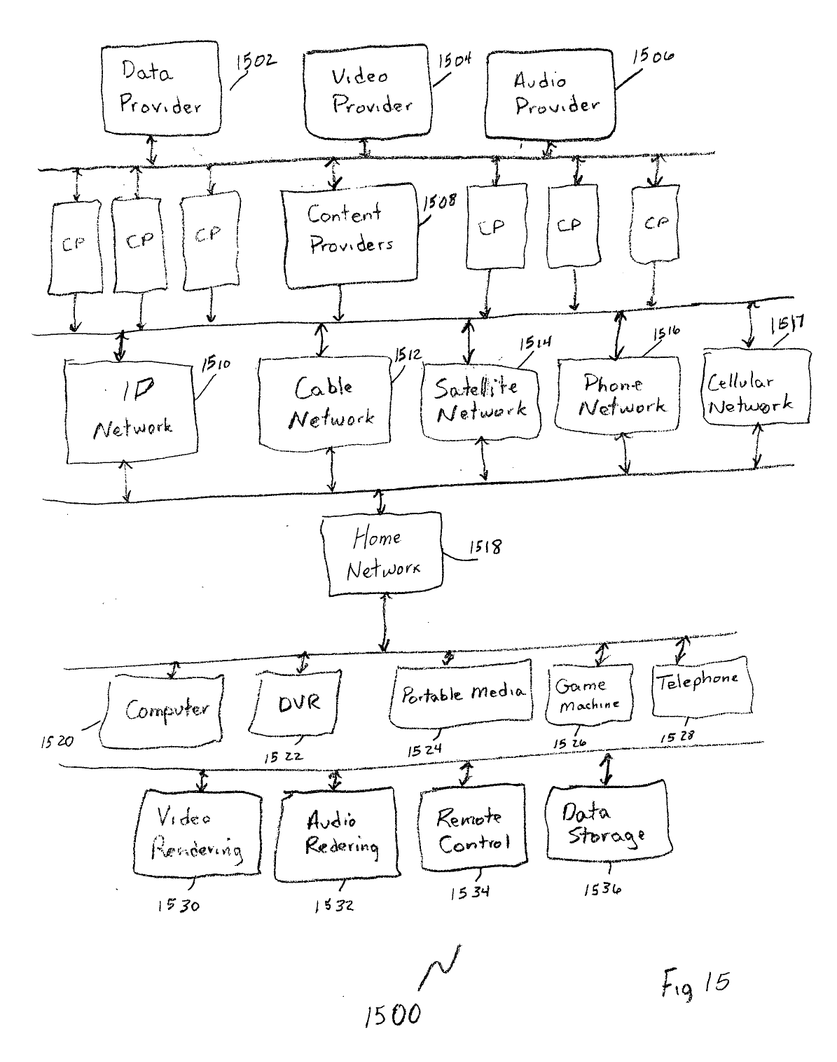

With reference to FIG. 15, a content distribution system 1500 is shown. Sources of content may include data providers 1502, video providers 1504 and audio providers 1506. The content provided by these various sources may be provided to any one of a number of content providers 1508. The content providers 1508 use various distribution networks including IP networks 1510, cable networks 1512, satellite networks 1514, PSTN telephone networks 1516 and cellular networks 1517. The content is received by hone networks 1518. The home networks 1518 may provide the content to devices or systems such as computer 1520, media recorders 152, portable media 1524, game machines 1526 and telephones 1528. These devices or systems may provide the content to video rendering systems 1530, audio rendering systems 1532 or data storage 1536. The devices and systems may be controlled by one or more remote control devices 1534.

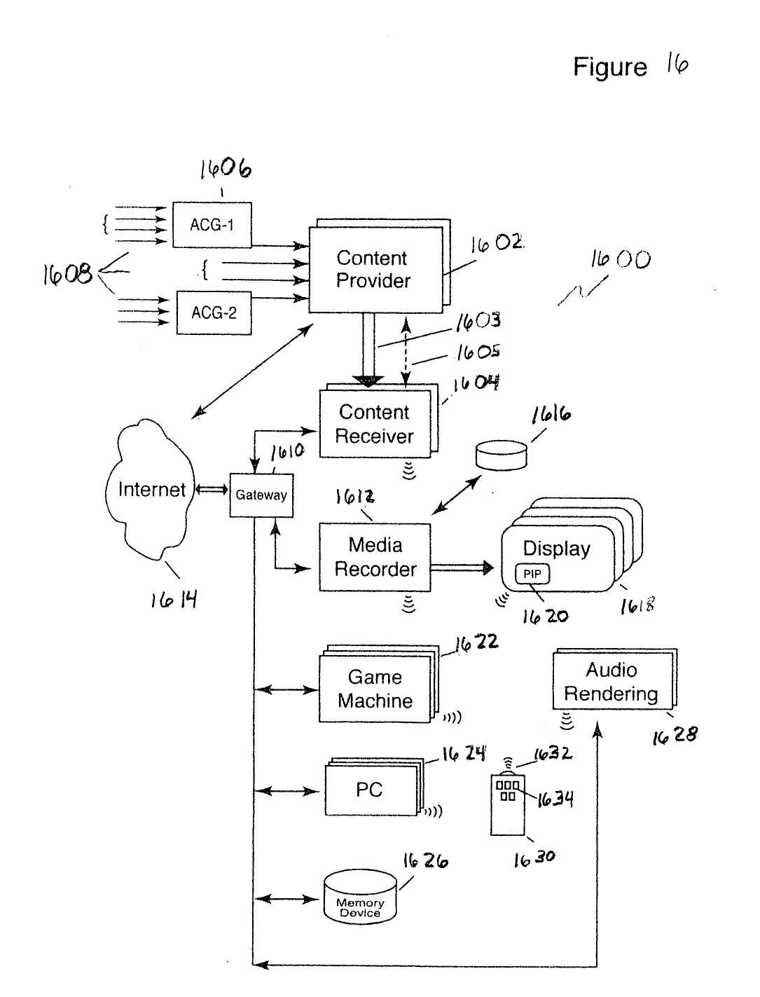

With reference to FIG. 16, a layered media distribution system 1600 is shown. A content provider 1602 provides associated content groups 1606 over a communication system 1603 to content receiver 1604. The content signal streams 1608 will be described as being transmitted over unique channels, however it will be recognized by those skilled in the art that the organization and encoding of the content signal streams may be implemented in other appropriate ways. Each associated content group 1606 includes a plurality of content signal streams 1608, each representing for example a channel of associated content. Typically, each associated content group 1606 may include a principal channel of audio-visual content. The associated content group 1606 may include broadcasts regarding a live event, such as sporting events, award shows, news features or other events of interest. The associated content group 1606 may include broadcasts regarding movies or other types of entertainment, documentaries and other educational information. As an example, one channel 1608 of an associated content group 1606 may be a broadcast of a sporting event. Associated channels might include a pre-recorded background documentary, a live commentary show, a viewable database of statistics, photos and film clips, and other content related to the program. An associated content group 1606 for an award show may include associated channels including clips of nominated performances, biographies, histories or other content that may be interesting to award show viewers. Some channels of information will clearly require less bandwidth than others. In accordance with one embodiment, the channels may be tailored to use only a necessary allocation of bandwidth. A secondary communication channel 1605 may connect the content provider 1602 to a content receiver 1604. In particular, where the content distribution network 1603 is a one-way connection such as a satellite distribution system the secondary communication channel 1605 may provide communication from the content receiver 1604 to the content provider 1602. A wide-area-network 1614 such as the Internet may be connected through a gateway 1610 to provide the secondary communication channel 1605. A media recorder 1612 may be connected to content receiver 1604. The media recorder 1612 may be connected to a memory 1616. The media recorder 1612 may be connected to visual rendering devices 1618 such as a television. The media recorder 1612 may be connected to game machines 1622, computers 1624, remote memory devices 1626 and audio rendering systems 1628. A remote control 1630 including input devices 1634 such as buttons may be used to communicate with other local devices using an infrared communication system 1632. The content on the channels 1608 of the associated content group 1606 may be broadcast simultaneously, so that a live viewer can surf between the associated channels 1608 at will on a real-time basis. Picture-in-picture 1620 may be used to view multiple associated channels. In some embodiments, more than one live event may be broadcast within an associated content group 1606. When a user elects to view content 1608 that is part of an associated content group 1606, either live or recorded, the supporting channels are received by a media controller 1604. Where a media recording system 1612 such as a digital video recorder is available, the primary program 1608 and supporting channels of the associated content group 1606 may be recorded.

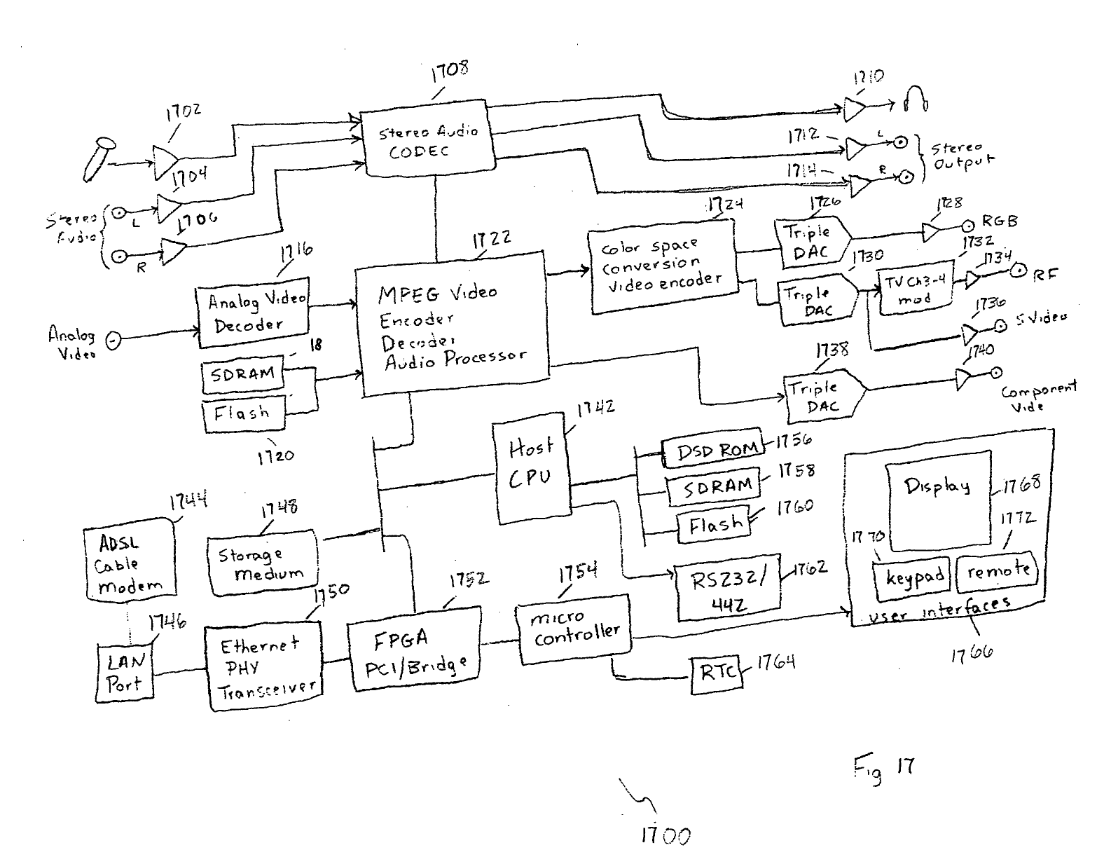

With reference to FIG. 17, a functional block diagram of a media recorder 1700 is shown. An analog video signal may be delivered to an analog video decoder 1716. The analog video decoder 1716 digitizes and decodes baseband analog video formats (NTSC/PAL/SECAM) into digital component video and delivers the decoded video signal to MPEG video encoder decoder audio processor 1722. The MPEG processor 1722 may receive data from memory units, such as SDRAM 1718 and Flash memory 1720. The MPEG processor may deliver an encoded video signal to a color space conversion video encoder 1724. The color space conversion video encoder 1724 may provide an encoded video signal to triple digital to analog converter 1726. The triple DAC 1726 converts digital video into analog video output in different formats: NTSC/PAL, S video, and YPrPb component video. The output stages require high-performance op-amps to amplify the video signals and may provide an RGB signal to amplifier 1728 for output to a rendering device. The color space conversion video encoder 1724 may provide an encoded video signal to triple DAC 1730 to provide a modulated RF signal from RF modulator 1732. The output of the RF modulator 1732 is delivered to amplifier 1734 for output to a rendering device. The output video signal of triple DAC 1730 may be provided to amplifier 1736 for output to a rendering device as a composite S-Video signal. MPEG processor 1722 may provide a content signal to a triple DAC 1738 for ouput to amplifier 1740, generate a component media signal. MPEG processor 1722 may be connected to a host processor 1742. The host processor 1742 controls the DVR operating system software, overlay of text/graphics, and the user interface and may receive data from memory units such as DSD ROM 1756, SDRAM 1758 or flash memory 1760. An RS232/442 1762 connection may be provided to the host processor 1742. The host processor 1742 and MPEG processor 1722 may store and read data from storage medium 1748. An ADSL Cable modem 1744 may provide network connectivity to the media recorder 1700. The modem 1744 may be connected to a LAN port 1746. An Ethernet PHY transceiver 1750, communicably connected to the LAN port 1746 communicates with FPGA PCI/Bridge 1752. FPGA PCI/Bridge 1752 provides data/command transfer between devices connecting to the PCI bus. A microcontroller 1754, connected to the FPGA PCI/Bridge 1752, connects to the user interfaces 1766 and RTC 1764. Audio input from a microphone or stereo output is amplified at amplifiers 1702, 1704 and 1706. The amplified signals are provided to a stereo audio codec 1708. The stereo audio codec 1708 uses audio ADC and DAC to digitize and playback analog audio, decoding the audio signals for output via amplifiers 1710, 1712 and 1714. The user interfaces 1766 may include a display 1768, a keypad 1770, an I/R remote control 1772 or other appropriate interface systems and devices.

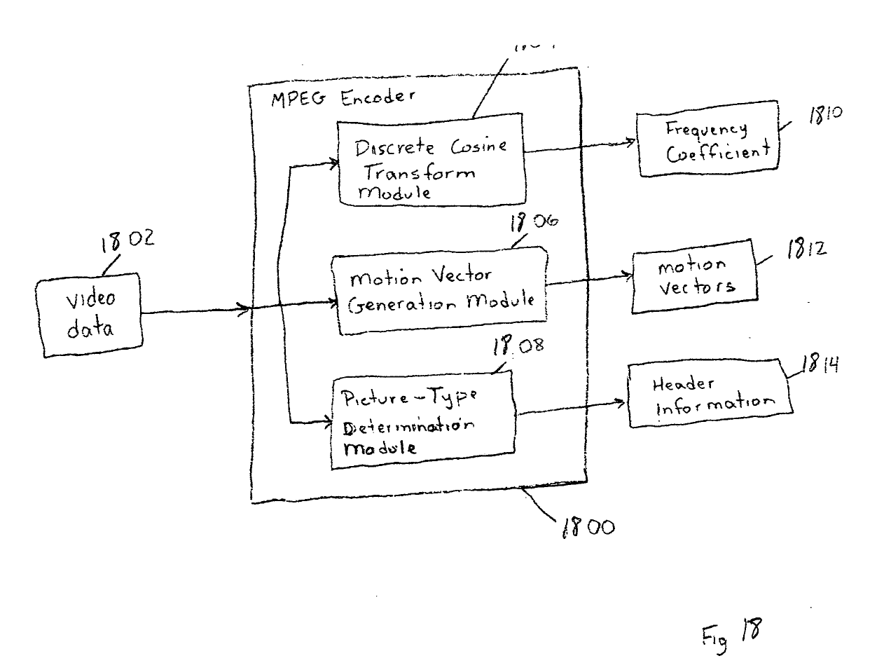

With reference to FIG. 18, an MPEG encoder 1800 is shown. MPEG encoder 1800 receives video data 1802. Video data 1802 may be formed from a sequence of video images. MPEG encoder 1800 typically includes a discrete cosine transform module 1804, a motion vector generation module 1806 and a picture type determination module 1808. The component modules separate video data 1804 into different requisite parts. The discrete cosine transform module 1804 transforms blocks of the video data from the spatial domain into a frequency domain representation of the same blocks. Motion vector generation module 1802 generates motion vectors representing motion between macroblock regions in the frames of video data 1802. Picture type determination module 1808 determines the frames that should be used as reference frames (I-frames). The encoded MPEG video bit stream may include frequency coefficients 1810, motion vectors 1812, and header information 1814 to specify size, picture coding type, etc.

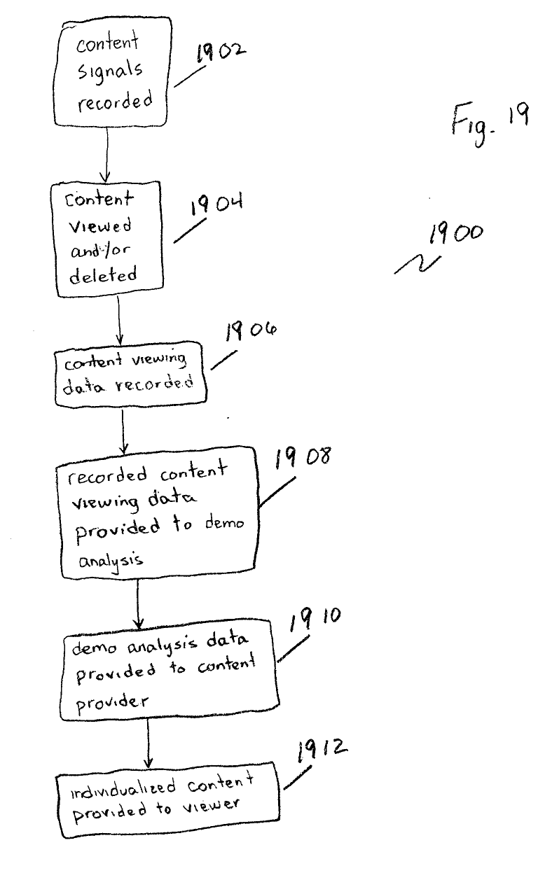

With reference to FIG. 19, a individualized content process 1900 is shown. Content signals are recorded with a media recorder at function block 1902. The content is viewed and/or deleted by a viewer at function block 1904. Content viewing data associating the content, the viewer and the manner of viewing is recorded at function block 1906. The recorded content viewing data is provided to a demographic analysis unit at function block 1908. Demographic analysis data is provided to a content provider at function block 1910. Individualized content is provided to a viewer by a content provider at function block 1912.

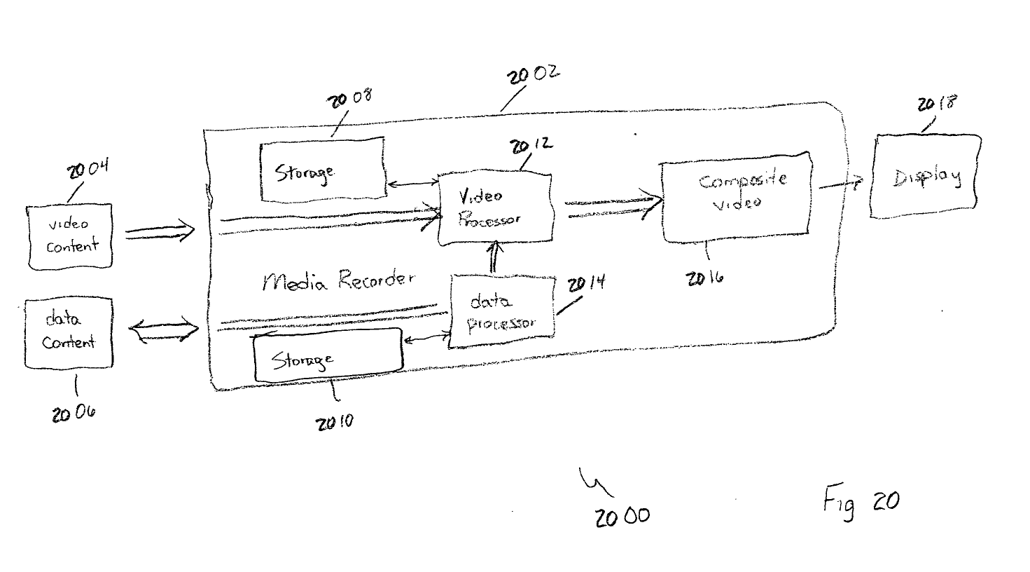

With reference to FIG. 20, a composite video media recorder system 2000 is shown. A media recorder 2002 receives video content 2004 and data content 2006. The video content 2004 may be provided to a video processor 2012. Content may be stored on storage device 2008. Data content 2006 may be provided to a data processor 2014. Content may be stored on storage device 2014. The video processor 2012 in communication with data processor 2014 may produce composite video 2016. The composite video 2016 may be rendered on display 2018.

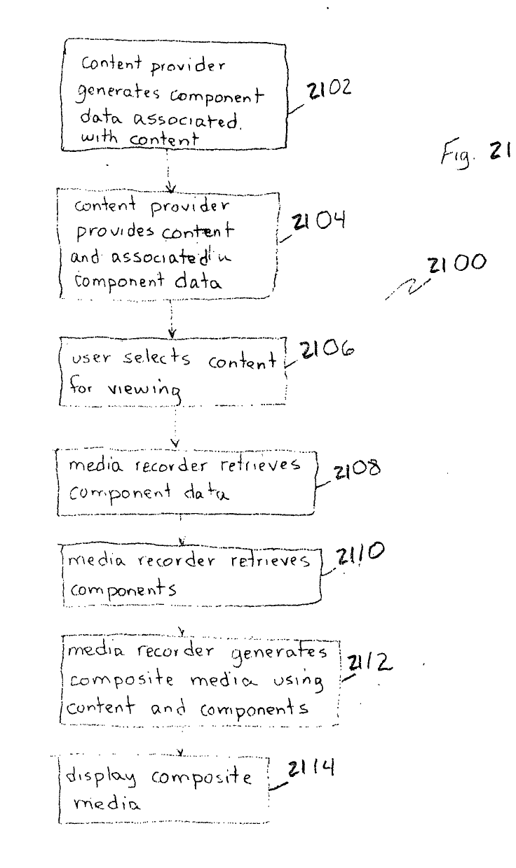

With reference to FIG. 21, a process for generating composite media 2100 is shown. A content provider generates component data associated with a particular content at function block 2102. For example, a sporting event content may be associated with sports-related thematic components. The component data may include the components or indicate an address where the component can be retrieved. The content provider broadcasts or otherwise distributes the content and the associated component data at function block 2104. The user selects the content for viewing on a media recorder at function block 2106. The media recorder retrieves the component data associated with the content at function block 2108. If necessary, the media recorder retrieves components that are not locally available at function block 2110. The media recorder generates composite media using the content and associated components at function block 2112. The composite media is displayed at function block 2114.

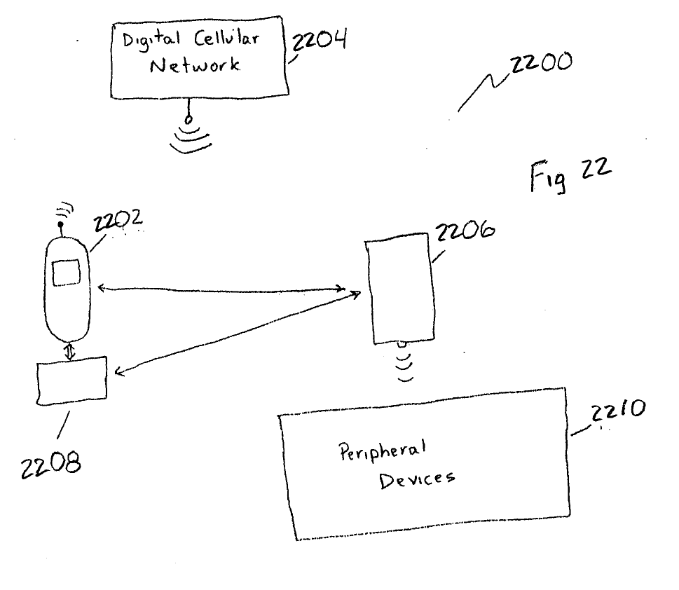

With reference to FIG. 22, a media recorder system 2200 is shown. A mobile phone 2202 is capable of transmitting and receiving multiple types of signals over a cellular network 2204. Typically, cellular network 2204 is a wireless telephony network that can be based on Code Division Multiple Access (CDMA), Time Division Multiple Access (TDMA), Global System for Mobile Communications (GSM), or other telephony protocols. A header embedded within incoming signals received by mobile phone 2202 from cellular network 2204 indicates the type of signal received. The most common type of signal is a voice signal for purposes of a carrying on a full-duplex conversation. Data signals, however, are becoming more common to cellular networks as mobile phones become more robust with respect to sending and receiving textual, audio, and image or video data. A received voice signal is typically decoded by mobile phone 2202 into an analog audio signal while a data signal is processed internally by appropriate hardware and software within mobile phone 2202. A multimedia signal is handled by mobile phone 2202 as containing separate voice and data components. Signals containing voice, data, or multimedia content are processed according to known wireless standards such as Short Messaging Service (SMS), Multimedia Messaging Service (MMS), or Adaptive Multi-Rate (AMR) for voice. Mobile phone 2202 is also capable of creating and transmitting a multimedia message over cellular network 2204 using an integrated microphone and camera if so equipped. Multimedia messages can be created by the mobile phone 2202 via direct user manipulation or remotely from a remote 2206. Mobile phone 2202 is further capable of re-transmitting or relaying a received signal from cellular network 2204 to remote 2206 and vice-versa. Communication to and from remote 2206 is over a wireless protocol using a licensed or unlicensed frequency band having enough bandwidth to accommodate digital voice, data, or multimedia signals. For example, it can be based on the Bluetooth, the 802.11 (a, b, g, h, or x) protocols, or other known protocol using the 2.4 GHz, 5.8 GHz, 900 MHz, or 800 MHz spectrum. To facilitate interaction with remote 2206, mobile phone 2202 may use a separate lower power RF unit from the primary RF unit used for interaction with cellular network 2204. If mobile phone 2202 is not equipped with the capability to interact with remote 2206, then a base unit 2208 can be used to interact with remote 2206. Mobile phone 2202 can be positioned in base unit 2208 in such a way as to allow a signal received by mobile phone 2202 to be communicated over a serial communications port to base unit 2208. Likewise, base unit 2208 may be equipped with a serial communications port to receive signals from mobile phone 2202. Base unit 2208 is also equipped with an RF unit so as to be able to interact with remote 2206. Further, base unit 2208 can act as an intermediary between mobile phone 2202 and remote 2206. Specifically, base unit 2208 can transmit and receive signals between mobile phone 2202 and remote 2206. Base unit 2208 may typically have access to an independent power source. Access to a power source allows base unit 2208 to transmit and receive signals over longer distances than the mobile phone 2202 is capable of transmitting and receiving signals with its reduced power secondary RF unit. In fact, base unit 2208 may be used even if mobile phone 2202 is equipped to interact with remote 2206 in order to accommodate communication over a longer distance. The power source also allows base unit 2208 to perform its primary duty of re-charging the battery in mobile phone 2202. Remote 2206 may be equipped with an RF unit for interacting with mobile phone 2202 and/or base unit 2208. Specifically, remote 2206 may transmit and receive signals to and from mobile phone 2202 and may transmit signals to other peripheral devices 2210. Typically, peripheral devices may include home entertainment system components such as a television, a stereo including associated speakers, or a personal computer (PC). Remote 2206 may include a digital signal processor (DSP)/microprocessor having multimedia codec capabilities. Remote 2206 may be equipped with a microphone and speaker to enable a user to conduct a conversation through mobile phone 2202 in a full-duplex manner. By including a microphone and speaker, remote 2206 maybe used as an extension telephone to carry out a conversation that was initiated by mobile phone 2202. Remote 2206 may access and control aspects of mobile phone 2202. For example, remote control 2206 may access mobile phone 2202 to enable voice dialing or to create an SMS or MMS message. Remote 2206 may have the ability to relay, re-route, or re-transmit signals to other peripheral devices 2210 that are under the control of remote 2206. These other electronic devices may also be controlled by remote 2206 using, for example, an infrared or RF link. Remote 2206 may route re-transmit a signal from mobile phone 2202 or base unit 2208 directly to other peripheral devices 2210. A picture caller ID signal, received by mobile phone 2202 from cellular network 2204, for instance, can be automatically forwarded by either mobile phone 2202 or base unit 2208 to remote 2206 and then on to a television for display. Remote 2206 also contains an internal, rechargeable power supply to facilitate untethered operation. If the peripheral device 2210 is a television, for instance, the television can receive re-transmitted or relayed signals from remote 2206. For the convenience of the user, an incoming call can trigger a chain of events that ensures the user does not miss anything being watched on the television. Many televisions are now equipped, either internally or via a controllable accessory, with a digital video recorder that has the ability to pause live television and save video data to a hard drive. Thus, if a call is received on mobile phone 2202 and mobile phone 2202 is out of reach of the user, then the call information and the call itself can be forwarded to remote 2206. If the user decides to answer the call using remote 2206, then remote 2206 could cause the television to pause until the call is complete or the user overrides the pause function. A television includes integrated speakers capable of broadcasting audio. Further, many televisions are capable of displaying both digital and analog video as well as displaying and/or broadcasting multimedia in commonly know wireless executable formats including, but not limited to, MMS, SMS, Caller ID, Picture Caller ID, and Joint Photographic Experts Group (JPEG). Similarly, audio may be broadcasted in a variety of formats including, but not limited to, Musical Instrument Digital Interface (MIDI) or MPEG Audio Layer 3 (MP3). Voice, data, audio, or MMS message executions can be displayed in a “picture in picture” window on a television. Thus, data originally intended for and received by mobile phone 2202 can be routed or re-transmitted to a television via remote 2206 to enhance the look and sound of the data on a larger screen display. A television may also be compatible with other peripheral devices in a home entertainment system including, but not limited to, high-power speakers, a digital video recorder (DVR), digital video disc (DVD) players, videocassette recorders (VCRs), and gaming systems. A television may also contain multimedia codec abilities. The codec provides the television with the capability to synchronize audio and video for displaying multimedia messages without frame lagging, echo, or delay while simultaneously carrying on a full-duplex conversation with its speaker output and audio input received from remote 2206 via mobile phone 2202 or base unit 2208. High-power speakers can receive audio from a wired connection from a television or from a tuner, amplifier, or other similar audio device common in a home entertainment system. Alternatively, the speakers can be fitted with an RF unit to be compatible with remote 2206. If the speakers are wireless-capable, they can output audio from mobile phone 2202, base unit 2208, remote 2206, or a television. Audio generated at mobile phone 2202 or base unit 2208 can be routed directly to he speakers through a decision enacted at remote 2206. Similarly, a DVR can be wired directly to a television or alternatively can contain an RF unit compatible with remote 2206. A DVR is capable of automatically recording signals displayed by a television when an incoming signal from cellular network 2204 is received by mobile phone 2202. This capability allows the incoming communication to/from cellular network 2204 to override the normal video and audio capabilities of the television. The audio and video capabilities of the television can then be employed for communication interaction with cellular network 2204 while the DVR ensures that any audio or video displaced by this feature is not lost but is instead captured for later display. Peripheral devices 2210 can include, but are not limited to, personal video recorders, DVD players, VCRs, and gaming systems. Peripheral devices 2210 can be fitted with an RF unit compatible with remote 2206. This compatibility allows peripheral devices 2210 to recognize when mobile phone 2202 receives an incoming signal from cellular network 2204. When an incoming signal is recognized by a peripheral device 2210 such as a television, it can automatically pause operation so that the television can be used to interact with the incoming communication. Pausing operations may include, but are not limited to, pausing a recording operation, pausing a game, or pausing a movie display depending on the peripheral device in question.

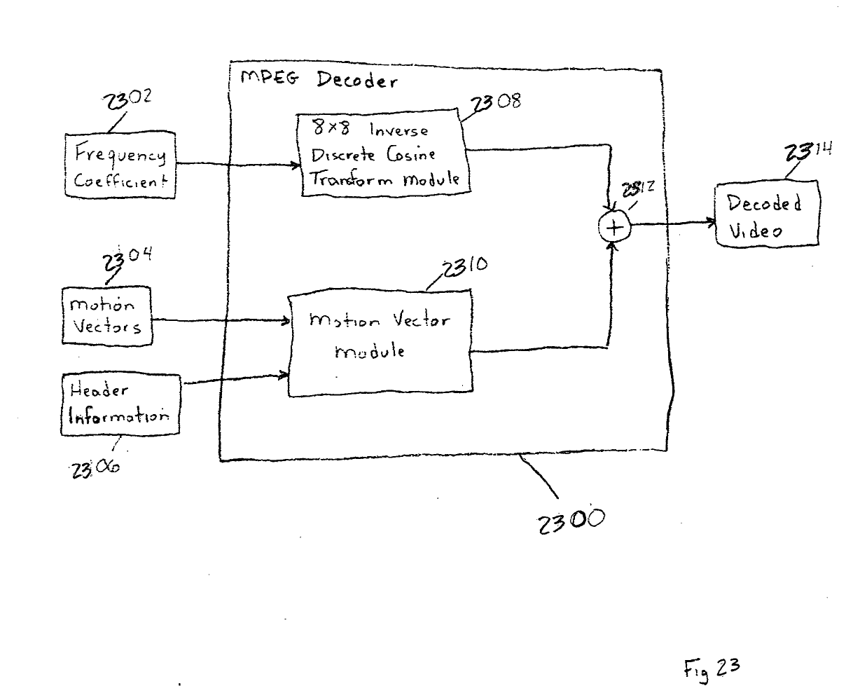

With reference to FIG. 23, an MPEG decoder 2300 is shown. To reconstruct the original sequence of video images from the encoded signals, inverse operations are performed. Frequency coefficients 2302 are dequantized and passed though inverse discrete cosine transform module 2308, converting them back into spatial domain representations. Motion vector module 2310 uses header information 2306 and motion vectors 2304 to recreate the macroblocks of P-frames and B-frames. The outputs from inverse discrete cosine transform module 2308 and motion vector module 2310 are then summed by summer 2312 to generate reconstructed output 2314. Reconstructed output 2314 is a sequence of video images similar to the video signal that was encoded and can be displayed on a display device.

It will be appreciated by those skilled in the art having the benefit of this disclosure that this invention provides a system of providing layered media content. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A process of providing a content display signal including display components comprises the steps of:
receiving input indicating display components;
receiving input indicating content;
generating a composite signal including indicated display components and indicated content;
providing said composite signal to a display device.
